(19) United States
(12) Patent Application Publication
(10) Pub. No.: US 2013/0174074 A1
(43) Pub. Date: Jul. 4, 2013

(54) Method and device for arranging information that is linked in complex ways and for pathfinding in such information

(71) Applicant: Peter Strzygowski, Berlin (DE)

(72) Inventor: Peter Strzygowski, Berlin (DE)

(73) Assignee: Mr. Peter Strzygowski, Berlin (DE)

(21) Appl. No.: 13/555,051

(22) Filed: Jul. 20, 2012

(30) Foreign Application Priority Data
Jul. 21, 2011 (DE) 10 2011 108 079.5

(51) Int. Cl. G06F 3/048

(52) U.S. Cl. CPC G06F 3/048
USPC 715/771

(57) ABSTRACT

The invention concerns the field of displaying information, specifically the automated arrangement of displayed data that are linked in complex ways in limited display areas, e.g., computer screens, or in limited space for three-dimensional displays. Using the method, interlinked information (one-dimensional or multi-dimensional, directed and undirected graphs, finite multigraphs, and even “quivers”) can be displayed in the form of a navigable user interface through the special arrangement of the representatives standing for the information content, for example to display the relationships in social networks, genealogies, scientific work. The novelty resides in the method of the arrangement of the representatives of the information content, in the resulting arrangement and the resulting user interface for exploring content of said graphs. Representatives may be words or graphic symbols (areas, circles, etc.). The invention further enables small computers and devices like braille interfaces to display content of complex graphs.

### FIELD

The invention concerns the field of displaying information, specifically the automated arrangement of displayed data that are linked in complex ways in limited display areas, e.g., computer screens, or in limited space for three-dimensional displays. The method is preferably implemented by means of computers.

Using the method, interlinked information (one-dimensional or multi-dimensional, directed and undirected graphs, finite multigraphs, and even “quivers”) can be displayed in the form of a navigable user interface through the special arrangement of the representatives standing for the information content, for example to display the relationships in social networks, genealogies, scientific work. The novelty resides in the method of the arrangement of the representatives of the information content, in the resulting arrangement and the resulting user interface for exploring content of said graphs. Representatives may be words or graphic symbols (areas, circles, etc.).

### Problem to be Solved

### Introduction

Ordering is an activity familiar to everyone from childhood on, and has long been the subject of technical inventions for automation because of its universal necessity. Ordering consists initially in finding relationships between individual elements in accordance with defined criteria, and is thus an intellectual activity. The choice of the criteria that forms the basis for the ordering is abstract, since it depends on the goal of the ordering activity. Once the criteria have been defined, the option of reproducing the activity of ordering in technical systems suggests itself, because this activity is characterized by repetitive processes, and thus can be automated. This activity can be a tangible activity, potentially a physical activity.

Simple orderings with few criteria can be represented hierarchically.

Hierarchical ordering is most widespread in the technical world owing to computers, for example in control menus of programs or the file view in “File Explorer.” Here, the content of the harddisk is displayed, usually as a view of the primary aspect “file name,” if desired together with the attributes “date” and “file size”.

In “real life” (for example in business), however, relationships exist that cannot be represented hierarchically because they have a more complex structure, e.g., social networks or production systems. There is a need to be able to represent precisely this type of content in technical systems along with as much of the structure-determining information as possible, and to make it accessible to users—for example on computer screens. Until now, this has only been possible using expert systems. The invention provides a novel solution to this problem.

### Novel Solution

The problem solved by the present invention was previously unsolved; the solution and approach are new.

Most conditions in real life cannot be completely captured with their multiple aspects in the hierarchical representation of a list, nor can they be presented as a list.

Now, what needs to be considered—concerning this invention—in considering the word“presentation”: “presentation” is not meant as the “design” (visual/esthetic implementation) or the “ergonomics” (user-friendly design in accordance with psychological aspects of perception). Instead, “presentation” should be considered as the output of visually identifiable mapping of individual content elements, which consist of one or more individual pieces of information in different categories and the links of these individual pieces of information to each other or to other individual pieces of information.

Thus, presentation means the creation of a representation that makes visible both the content of the system under consideration and the relationships within the displayed content—and thereby makes the content with its relationships accessible for practical use.

To presentate this content and these relationships means to output the information content that defines them. The more completely and intelligibly this is done, the better suited the presentation is for making the content identifiable. This is relevant primarily when the relationships between the content items are complex (e.g., directed, multiply connected, circular). For analysis and information accessibility (information retrieval), the content must be presented in a readable manner, and the location of each item in the given stock of data must be identifiable. For visual output of the content output usually a computer monitor (screen) is used, where the arranged representatives of the content items are displayed.

During the course of developing the invention, it became evident that displaying complex data content is impossible with a hierarchical presentation, but is possible with a presentation as a “graph,” or a combination of multiple graphs, or multi-dimensional graphs (“multigraphs”).

(In anticipation of this solution step, we shall introduce the terms nodes and edges here. “Nodes” are individual information elements that stand in connection with other elements, which is to say are linked. These links are called “edges”.)

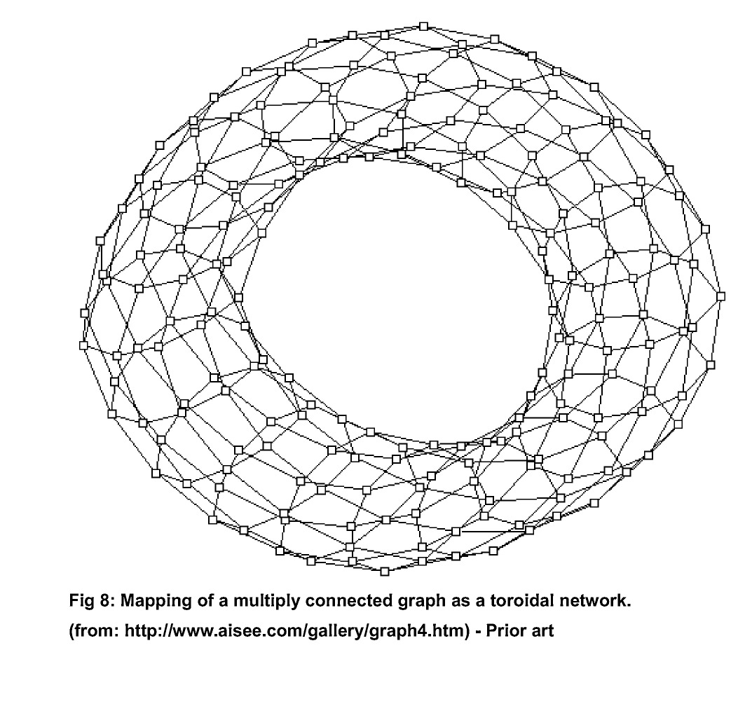

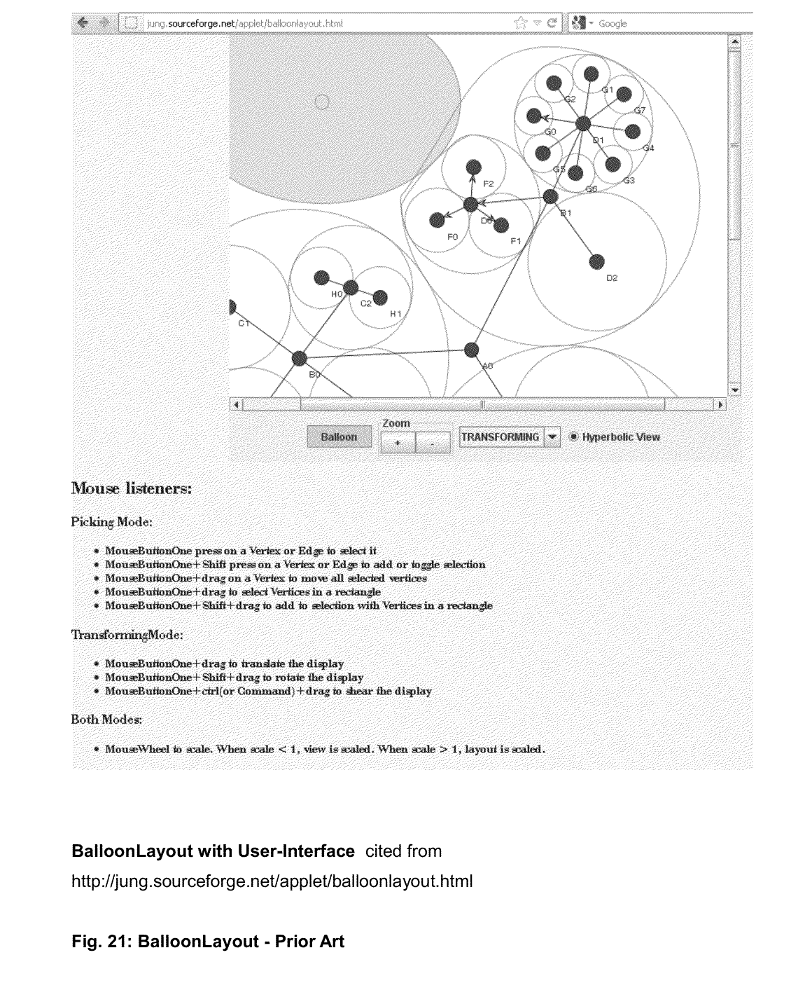

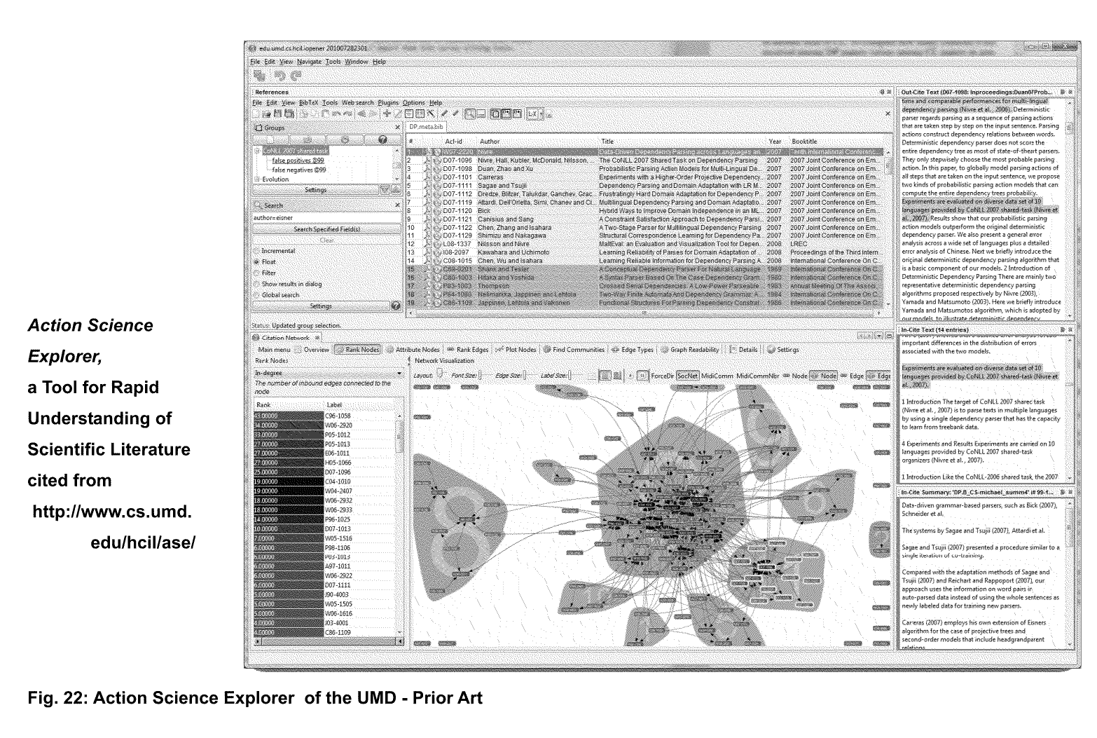

Graphs have heretofore (details under “prior art”) been presented
as two-dimensional arrangements (see FIG. 21)
as arrangements displayed as three dimensional (for example as networks; see ‘torus,’ FIGS. 8-10, or stacks arranged in space by specific criteria see FIG. 22).

The more elements are presented in the output, the less easily understandable the display becomes for large quantities of information or complex links, even in the case of graphs when many nodes and many edges are present. It becomes very difficult to understand when due to relationships in different categories nodes are multiply linked to one another (known as multigraphs).

It has heretofore not been possible to display an extensive multigraph on an office monitor in an easily understood manner, given that the individual content items have to be displayed such that they are clearly visible, readable and usable for usual users. Moreover, goal-oriented selection of an information element, an individual node, and the easily understood display and selection of the relationships of the nodes to one another (edges) generally has been impossible or extremely difficult heretofore.

Until now, it is not possible to trace the selection path (the pathfinding) through the set of information elements by prior art, a capability surprisingly made possible by the invention.

The implementations of the prior art are primarily suitable for gaining an overview or for visual grouping of sets of information, but are unsuitable or poorly suited for text-based detailed analysis of content information and the systematic tracing of links within the set of individual information items or the workflow while exploring these data.

Nevertheless, this systematic search and analysis of the existing connections between information components is important in many areas of daily life; for example, in the search for comparable, similar, or even different features within inorganic and organic natural or artificial substances (chemistry, bionics and other natural sciences), in the representation of connections and in searching within social groups, such as in social networks (Xing, Facebook, etc.), in the disclosure of connections between the components of machines with specification of the manufacturers, process paths, service lives, guarantee periods, etc., in the representation of commercial relationships (raw materials, delivery channels, availabilities, etc.), in the representation of family relationships and lineages in biology that can be traced using certain features and categories (configuration, genome, function, etc.), in visualization methods for biomedical data, in the retrieval of scientific publications or in data mining in neighborhood data. In like manner, it is possible to study historical, ethnic, linguistic, geological relationships, and much else. Subject areas can be explored individually or linked with one another in any desired combination and progression. Also including, for example, genealogical research, sports, project management, software development, hardware design, database administration, web design and web page optimization, network administration and analysis, computer science, bioinformatics, sociology and group psychology—studying social relationships and group behavior as a function of any desired parameters, such as origin, financial/occupational/health situation, family relationships, biographical relationships, interrelationships for the practical utilization of all manner of consulting, counseling, and coaching activities, such as employment counseling, organizational consulting, crime prevention, preventive health care, education planning, city planning, financial and investment planning, and so on and so forth.

While a “search” for relationships still could be categorized in abstract terms as intellectual effort, it becomes a really technical task as soon as the content described is supposed to be made visible and navigable in the area of a (customary office) output device (e.g., in the form of a 17″ monitor with 1024×768 pixels) or on a smaller device, e.g., an “iPhone” with a monitor having 320×480 pixels.

The output device (204) in this case represents a technical obstacle in achieving the goal. Display approaches from the prior art cannot be usefully employed on such monitors: the screen resolution is too small. This limitation resides within the data processing system (hereinafter referred to as “Dsystem”)(205) used in the method.

Any available output device is designed in such manner that only a limited output area is available with a limited number of picture elements (pixels); and hence only a limited quantity of information can be displayed in a readable manner. If, e.g., the text or icons are too small, then the output is no longer usable, since it is no longer readable.

This limitation on the part of the output device is also present in previously uncommon variants, such as output in the form of a three-dimensional representation (e.g., by means of stereographic or holographic displays) or actual spatial output (e.g., by means of 3D printers).

Thus, the output is technically limited by the technical conditions of the DP system. This technical obstacle must be overcome in order to display the potentially infinitely complex content of a multigraph. Moreover, the invention also makes it possible to presentate the likewise potentially infinitely long route of the “pathfinding,” which is an additional advantage of the invention since the indicated limitation of the DP system by the screen resolution is also an obstacle in this regard. So the invention enhances the state of the art.

Through its specific and novel teaching of the arrangement of representatives of the content elements, the invention provides the solution to the problem of making data, that are linked in complex ways and the pathfinding in such information, displayable and easily manageable on current DP systems, as well as it solves the problem of making it easy or indeed possible to operate DP systems for using these data.

The invention has application in numerous industrial, research, and practical contexts (see above). The content to be displayed varies depending on this context. This content is frequently only comprehensible to the specialist in the applicable field.

However, an example should introduce the teaching of the invention to every reader in an easily grasped way without being restricted by specialized information from unfamiliar subject areas. Consequently, the invention is presented in a context known to all, namely the organization of a school. The requirements and the possibilities of the invention in this example are similar to those in the industrial applications, so this example can explain the method well.

### EXAMPLE

“School” is a familiar environment that organizes human beings (with their distinct characteristics) in ordered relationships, such as, e.g., “classes,” and in which they take on various roles, such as “student” and “teacher.”

Thus, for example, the assignment of children to a school class is the feature through which the existence of a school class is defined. This relationship is not very complex, and can be mapped simply, e.g., can be represented in a list.

This restriction of the perspective on the complex reality of everyday school life to just one ‘important’ criterion (“membership in a school class”) permits a simplification through which it is possible to make the presentation hierarchical, and thus achieve simple comprehensibility in the presentation: here, just by way of example, in the order: “school class <-> associated children”. From this perspective, the association can also be presentated as follows: (school-age) child—(belongs to)—>school class.

However, the reality of life is more complex, since the entities always have additional properties also, or in other words, the school child is not defined only by the fact that he belongs to a class. For instance, a school child has certain teachers, whom he likes or does not like—and in most cases he also belongs to, e.g., one or more sports teams. Now, if the respective teachers and sports teams of each child are also to be noted in the list in addition to his class membership, the associations become significantly more complex and complicated. At the same time, additional ordering possibilities for presentating these connections arise, and consequently additional “views” of the content (for example, ordering the list by the names of the teachers).

In a hierarchical ordering, each “view” is oriented to a single primary criterion (another way to express this is “lists one dimension”), and thus represents a view of the complex overall system (“school”) that of necessity is restricted only to excerpts.

Creating lists that represent conditions such as the relationship “sports team->child” is possible. Within limits, hierarchical lists with complex links are also possible, such as “sports team->teacher->child”. But creating these compilations already entails a great deal of effort, since the content has to be filtered in accordance with the relationships—this is manually labor-intensive even for lists.

Depending on what limits one assumes for the system under consideration (“school”), the system can map and interlink any number of criteria of any number of entities, and thus become arbitrarily complex (for example, through the inclusion of hometown, hobbies, friendships, favorite color, achievements, absent days, . . . ). The presentation of the connections and the mapping of dependencies accordingly can become arbitrarily (=infinitely) complex. Using the prior art, this cannot be achieved in accordance with the object, as already noted.

### Object

Now, for example, in investment planning it can be necessary to ascertain, e.g., for resource-oriented student financial aid or for crime prevention, whether parental influences affect the children's grades and continuous school attendance, for instance contingent upon the hometown, whether connections exist in school class membership or whether the teacher influences the choice of favorite subject or whether a certain coach influences the children's motivation in behavior, attendance, or achievements in sports.

The raw data for this have already been gathered (through questionnaires, existing databases (students' addresses, religious affiliation, etc.), lists of grades, team lists) and assembled in a aggregate data set. This data aggregate includes many individual data items in various links (child-parents; child-sports team; sports team-coach; child-achievements (grades or sports); child-awards; child-absent days; parents-occupation; etc.).

During the course of analyzing these data, the intent is now to determine additional connections—for example: coach-team-children with best grades or most awards. It should be possible to carry out the task of displaying these connections and their locations in the given stock of data (data set), as well as the results and conclusions, using technical means within the framework of the existing technical environment of an office with standard equipment (for example, in the school's administrative office), and ordinary users (e.g., secretary, or school psychologist, school administration, guidance counselor . . . ) should be able to operate these means.

It is preferable to proceed from the premise that the analysis of the content can also take place on a device with a small monitor, which is to say, e.g., a “handheld” or “tablet computer.”

The person responsible for undertaking the study (hereinafter referred to as the “user”) first must learn to understand the connections between the data, which is to say must be able to recognize from the display the connections between the individual persons and the type of relationship/link. A purposeful selection of certain links must also be possible for the purposes of consideration; for example, the output of class->sports team->child (“The children on the sports teams in a specific class”).

If the user recognizes or suspects connections in this process, it must be possible to investigate them further. To this end, it must be possible to ascertain and display existing connections to other content elements in a simple manner (e.g., the favorite teacher or hometown when displaying the students in a class).

In the practical usage situation, therefore, the consideration of the connections of the content items represents the substance of the activity of the user. In addition possibly also an verbal introduction to the result and the derivation thereof with respect to an additional group (e.g., teaching staff, school administration, sponsors, parents' meetings) may be part of the mission.

The presentation of the connections between the content items of the system under consideration is the object to be achieved.

The production of the (easily understood) arrangement of the content elements and their filtering in accordance with the presentation context is the technical aspect of the object of the invention—so that these data can be utilized in a suitable manner. From the standpoint of the technical challenge, the object that is to be accomplished is the arrangement of all the content items to be displayed (=display of the content) on a technically limited output device with limited area (or space) so that they can be presented within the given technical framework of the DP system.

### PRIOR ART

Information about Publication by the Inventor:

The method according to the invention has been published at 28 Jul. 2011 in the form of screenshots of an arrangement generated in accordance with the invention of representatives of the content of the backend of the software system “screenbutler” on the website www.mitigate.de (later accessible at www.screenbutler.de). The first public use of the method by means of access to the password-protected backend of screenbutler took place in August 2011. A description of the operation of the method has been published since 23 Aug. 2011 (Deutsche Telekom competition).

In the following, attainment of the object in accordance with the prior art known to the inventor (without regard to his own publication) is examined in order to demonstrate the disadvantages of the prior art, followed by the advantages of the implementation according to the invention.

### Hierarchical Ordering:

The relationships between individual criteria (for example, school class->child) or (hometown->sports team) can be presented by means of a hierarchical ordering, as noted. This is possible when there is a primary criterion under which the content items can be classified since they have a direct relationship thereto (example: class->student).

There may also be additional criteria that are linked, and hence also additional hierarchical views that can be considered, for example, class->student->sports team, so that it is possible to show in a list which students in a class belong to which sports team, or (through primary weighting of the sports team) which sports teams are represented in a class and which students are on which sports team.

Who in this ordering is friends with whom (and is on the same sports team for this reason alone) cannot be displayed in this manner: this would introduce an additional “dimension” into the display. In the list display the possibility of showing links and the navigation in these data are thus characterized by the ordering of the relationships in a hierarchical way; in the case of complex content systems, this represents a significant limitation.

Traditionally, such excerpted representations of reality are displayed on computers in hierarchical menus, as is taught, e.g., in U.S. Pat. No. 7,802,203. Hierarchically ordered data can be arranged and can also be used for navigation towards content in this way.

Any hierarchical representation always relates to a single ‘important’ feature (the primary criterion, usually defined by the developer of the system in question) that permits a grouping of elements (subgroup), which can then be further classified. The deeper the descent into a hierarchical structure, the fewer elements of the whole are displayed (because, as a general rule, each selection reduces the number of remaining elements since they represent an intersection of the selections). In any case, the “crosswise” relationship of the subgroups to one another cannot be established directly; consequently, the contents of the subgroups cannot be placed in relationship to one another.

Example: The number of students output will continue to decrease with each step in the selection process: class->sports team->desired college. Finding out which colleges are named in the class at all is resource-intensive in this hierarchization. Which children at the school desire a certain college can only be determined with great effort in this case.

In hierarchical displays it is always necessary to go ‘back,’ which is to say to higher hierarchy levels of the presentation, in order to increase the number of selectable elements.

In the case of a presentation by means of display the menu of a computer program, this means going back up one menu level in order to be able to make a different selection there, with which the user then goes back down one level. The resultant lack of clarity in the menu is certainly familiar to most of the users of current computer systems.

In order to compile all the colleges in our example, the selection path must be traveled many times. This arrangement thus is not well suited for an easily understood presentation of complex links—nor can the content be “explored” in this way.

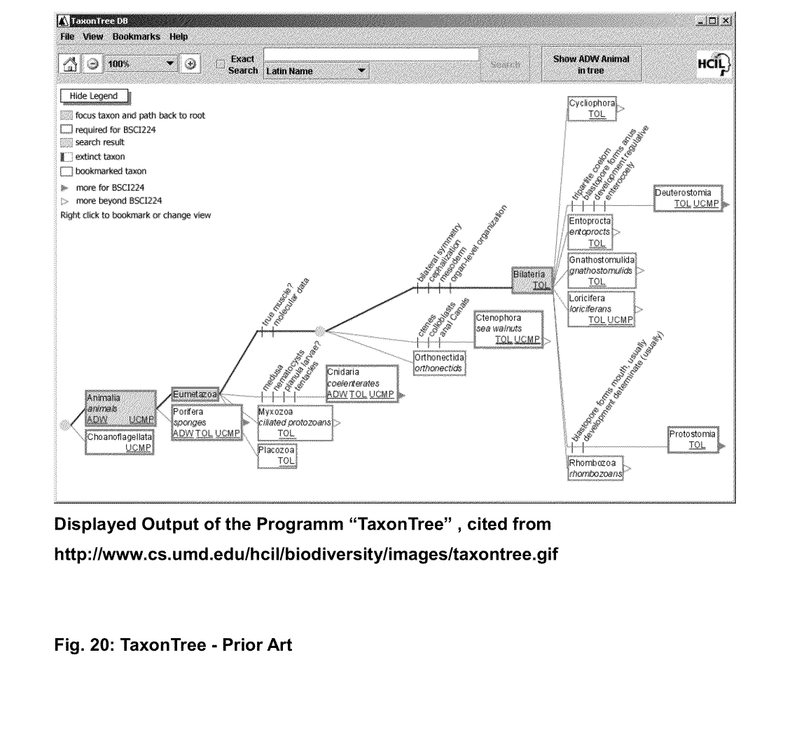

From the research work of the University of Maryland, presentation types such as TaxonTree (see Fig. 20, from http://www.cs.umd.edu/hcil/biodiversity/images/taxontree.gif) are additionally known; What is noteworthy here is the ability to explicitly display the path resulting from the pathfinding (blue line) to the actual content item. However, if one goes back in the selection, this path is not shown, with the result that the various search paths cannot be retraced.

Despite its complexity and richness of content, the order displayed in this example of TaxonTree is merely a hierarchical representation (tree display), with additional information being appended to its nodes. Because these additional informations in the nodes are not linked, TaxonTree is providing a hierarchical presentation, not a (multi)graph presentation. The problem of accommodating the large data set on the limited display screen is handled here such that a portion (on the left) of the tree is cut off, which is to say is not shown, but instead is represented by an arrow. As a result, the overall context is lost.

### More Complex Geometric Arrangements

Patent applications in the field of the methods for arranging information, and also practical implementations thereof, are known. However, as will be made clear below, they are not suitable for achieving the object of the present invention.

Methods of accomplishing the display of content items linked in complex ways by means of a geometric arrangement, for example by displaying the overall context as a three-dimensional space or as tree or 2-dimensional arrangement of squares, have been described time and again. In these approaches, the hierarchical ordering of the data has been the dominant means for ordering and display, even when displaying graphs.

Graphs have heretofore (see details further below) been displayed in two ways
as two-dimensional arrangements
as arrangements displayed in three dimensions (for example as net, see ‘torus’ mapping or as stacks arranged in space by specific criteria).

Existing systems fail when displaying multiply connected graphs.

For example, this is also the case in the European Patent EP1105817 (see EP1105817B1.pdf), in which a spatial arrangement is proposed that establishes the connections between files through a geometric arrangement with reference to the “relatedness” of the individual files. The content items here are always displayed as non-categorized data in which only a single association/link is shown—which is to say solely one dimension, in the example in that patent application the ‘hyperlink’ to other files.

The presentation proposed in the cited patent reaches its limits in the case of more complex connections, even in the case of an assumed restriction of the link complexity to a single dimension. Since this was also noted by the inventor of the cited patent, the possibility of mapping circular connections (ring-shaped, potentially taking place over multiple steps) is explicitly excluded in the description of the invention.

Since circular connections inevitably arise in complex systems, this system of arrangement cannot be used for attaining our object.

A form of presenting and displaying linked data that likewise is suitable for only one content dimension (in other words, displaying one category) is that of the “tag cloud.” “Tag clouds” are “word clouds” that routinely display the terms in a specific category to which the cloud is thematically related (see, e.g., www.tagcloud-generator.com; see tag_cloud_generator.pdf). With a cloud, only data that belong to a single category (content level) can be usefully presentated. Displaying the associations of multiple categories is possible to some extent if the terms are marked in color. In a conceivable further nesting of the arrangement ease of understanding would be greatly reduced, with the result that information items would no longer be identifiable.

A cloud shown as a three-dimensional presentation (3D tag cloud) is the state of the art for presentating data that are linked in a visibly displayed net structure. In our example, it would be possible in this way to presentate the social connections of the students to one another, thus “student A—knows-→student B.” Particularly lively/popular students would be identifiable by the concentration of reference lines, or the number of contacts could additionally be shown by the size of the letters. Multiple dimensions could be represented by colors, but without further content markup.

Movable 3D tag clouds, in which it is possible to navigate, are known. In this context, “navigating” means to purposefully home in on terms and potentially click on them, for example, in order to trigger further actions, e.g. to highlight them and their connections and to extract information associated with them. Navigation is relatively difficult, because handling the 3D tag cloud is not simple, and it is possibly very agile. Precise navigation is difficult for the user, and “going back” in the case of an erroneous selection is correspondingly complicated.

3D tag clouds likewise routinely presentate only the terms from a single category to which the cloud is thematically related.

Additional information on the content elements and additional content categories offered for selection must be placed outside the display.

For reasons including those stated, tag clouds are not suitable for attaining the object of the invention.

Other prior art notations for mapping graphs likewise do not attain the object of the invention, since they are not navigable by inexperienced users and are quite complex in appearance, and/or cannot display additional information, or the notations can only display content in a single category in any case.

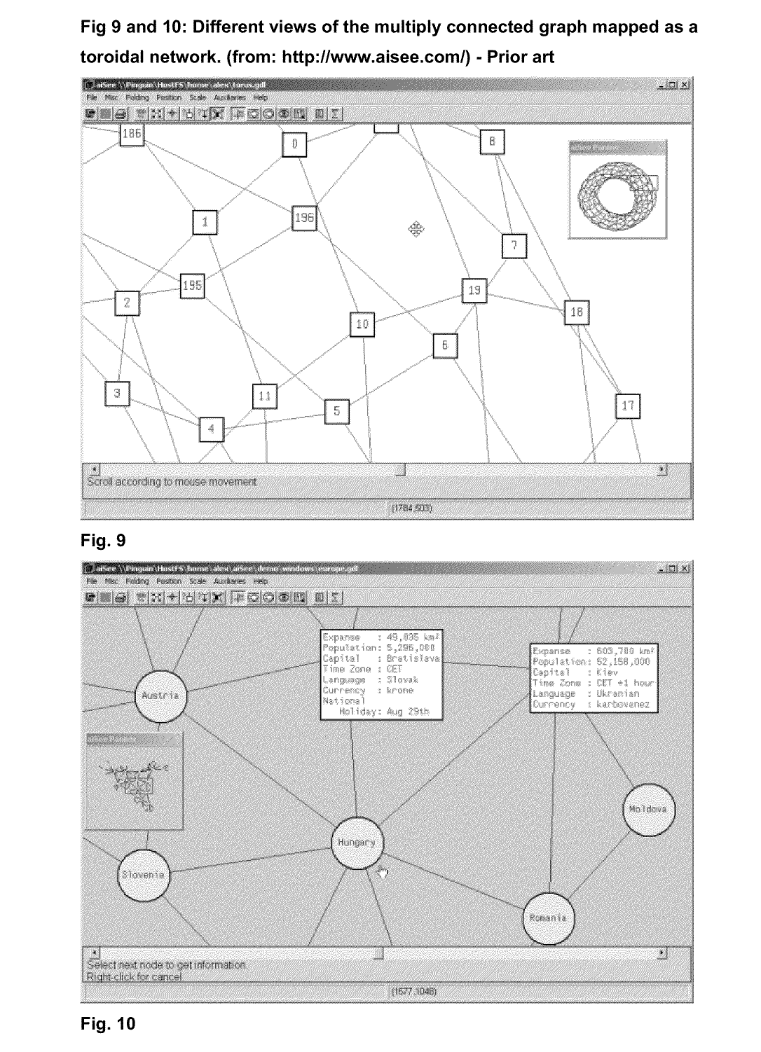

See, e.g., torus, Fig 8, from URL: http://www.aisee.com/ and the implementation in the visualization program, Fig 9 and 10.

The inventor is aware of publications including current publications (see below) on the subject of displaying the content of complex graphs and multigraphs. The following examples represent various attempts to resolve the problems arising in this subject area. None of the systems can display multiply interlinked multigraphs with directed and undirected edges and circular relationships (called quivers) in a manner appropriate to the object (example “school”). As can readily be seen, they consequently would not be suitable for the object we have described.

### Known Examples

->basic visualization system for graphs, e.g., Zest: http://www.eclipse.org/gef/zest/index.php see ZEST.pdf
->GUESS, a dynamic system for visualization of the connections in a multidimensional graph: http://graphexploration.cond.org/; screenshot see GUESS.pdf
->JUNG (Java Universal Network/Graph Framework. JUNG is a software library that provides a common and extendible language for the modeling, analysis, and visualization of data that can be represented as a graph or network.->http://jung.sourceforge.net/
e.g., introducing various layouts for displaying various graphs: p. 1 of JUNG.pdf cited from http://jung.sourceforge.net/applet/showlayouts2.html
typical examples are the “tree layout” and the “radial layout”: see p. 3 of JUNG.pdf cited from http://jung.sourceforge.net/applet/treelayout.html or further developments such as the ‘Balloon’ layout with ‘Hyperbolic View’: see Fig. 21 and p. 2 of JUNG.pdf (similar to the cited European Patent EP1105817),
UOFS—mapping or showing association through colored shading: http://code.google.com/p/uofs-silver-hg/A
additional innovative developments may be found at the University of Maryland; http://www.cs.umd.edu/hcil/graphvis/ see MARYLAND.pdf

All these approaches develop the basic concept of spatially displaying multidimensional graphs, which are then zoomed in to display details. This also applies to ‘planar representations’ (TreeMaps), which have long been commonplace and can display relationships, but are inadequate for the task of displaying content of additional dimensions (which is to say of a multigraph) in an easily understood manner; see http://www.cs.umd.edu/hcil/treemap-history/ see treemaps-shneiderman.pdf

The displays heretofore described are graphically intensive and difficult to understand. Typically they only become suitable for general use when the user can “zoom into” them, or in other words, the mapping scale is increased such that the individual components of a desired segment of the overall region are identifiable/readable. As a result, however, at the same time a part of the overall network is not shown in the mapping, and is inaccessible. Handling of these displays is only possible at all with monitors having very high resolution (see Fig 22, Action Science Explorer).

One approach for satisfying the requirement for the visibility of as many content elements (nodes) and their connections (edges) as possible, and the most simultaneous possible visibility of as many content elements as possible, is the “Semantic Zoom.”

Quote from “Design Patterns for ZUI Interfaces—Pattern 17: Semantic Zooming: “It is useful for an object to change its visual representation based on the scale that it is being viewed at. For example when a document is viewed from far away (at a small scale) in a ZUI it might be best to just show that documents title, but when the view is zoomed in all the documents content should become visible.”

(Quote 23.6.2012. Source http://www.piccolo2d.org/learn/patterns.html#Desing_Patterns_for_ZUI_Interfaces) This principle is possible for the ‘balloon’ layout, for example—but does not mitigate its limitations with regard to the comprehensibility of the arrangement.

One current development that implements the previously known findings is http://truthy.indiana.edu/ (visualizing Twitter data, e.g., barackobama_Truthy.pdf)—another is, for example, the graphics program Gephi: http://gephi.org/features/(“Gephi is a tool for people that have to explore and understand graphs. Like Photoshop but for data, the user interacts with the representation, manipulate the structures, shapes and colors to reveal hidden properties.”)

These implementations are equally unable to deal with the challenges of the object.

To the best of my knowledge, these approaches are from the time period 1990-2005. It can thus be seen that no truly new approach in the efforts to display data linked in complex ways has been developed since the 1990s, even though the demand for readable information presentations that can be evaluated has continued to grow.

It can be concluded from very recent publications that the approaches still remain the same.

For example: Rodrigues, E., Milic-Frayling, N., Smith, M., Shneiderman, B., Hansen, D.:

### Group-in-a-Box Layout for Multi-Faceted Analysis of Communities

Published in Proc. IEEE Conference on Social Computing, IEEE Press, Piscataway, N.J. (October 2011). See, in particular, pages 3 and 4 in In-a-Box_{—}2011.pdf)

### Disadvantages of Existing Approaches:

The disadvantages of the existing approaches of prior art concerning presentating complex data network are evident. With the existing solutions, it is not possible to use customary office computer systems or even low-performance computer systems to display data linked in complex ways, nor is it possible to use devices with small display screens, such as mobile devices or small tablet computers.

### Solution by the Invention

### Improvements to the State of the Art and Utility

The invention breaks new technical ground with the method for arranging the content items of systems that are linked in complex ways.

At the same time, the invention is useful because it teaches a way to display the content of graphs that are linked in complex ways in a limited area (or limited space), with the result that such data linkages can be presentated on computers in a comprehensible and usable manner. By the means of the invention, even a low-performance computer with a small display screen and a low-performance graphics card can be used for the display.

Moreover, the method according to the invention makes dynamic ‘pathfinding’ in the data possible; the link information items are converted into navigation elements arranged according to the invention, making it possible to navigate in the content (pathfinding). The content links are made readable for the user and can contribute to understanding the data. In this way, a reduction in the time required for (intellectually) apprehending the presentation and for research can be achieved.

In concrete terms, the technical invention is useful for presentating an arbitrarily large data set on a computer screen (of limited size) in an easily understood way, so that the content linkage/the content relationship of the elements becomes evident and navigation (movement) between the elements (or in abstract terms, within the data pool) is possible. The above examplary task (“school”), for instance, can be accomplished by using the invention, as can the other designated tasks—such as presentating family relationships, literature searches, social networks, commercial relationships, etc.—listed in detail by way of example on pp. 4.

Moreover, using the method according to the invention, the presentation of complex content relationships can be accomplished on other output devices as well (for example, 3D display devices such as, e.g., 3D stereoscopic displays), 3D output devices (for example, 3D printers or lasers) or 2D output devices (for example, printers, plotters, etc.).

In hierarchical arrangements, the number of remaining elements is reduced by each selection, and consequently only an incomplete image of reality is presentated. In contrast thereto, the present innovation presentates a greater number of that links that exist at any given time from the content element then being considered to categories and the linked content elements.

Due to the presentation of the “pathfinding” in accordance with the invention, the overall context is always easily comprehended, clear, and retraceable as well.

The method according to the invention offers a novel, flexible option for accessing stored data through a computer interface, for navigating in the data with regard to their content relationships, and for comprehensively displaying data connections.

Due to the arrangement according to the invention, multi-dimensional links can also be displayed in a meaningful way. The content items are arranged for display such that the user obtains significant advantages during use, particularly for complex data structures. This happens in a way that allows DP systems with smaller monitors or lower-performance graphic cards to carry out this task. A larger number of computers become enabled for such an object.

### Attaining the Object:

To attain the object, it is described below. The description contains both the differentiation of the object with regard to content and the description of the technical steps and conditions required for the solution. These steps and the relationship to these conditions are already part of the solution according to the invention.

### Multigraphs and Computer-Implemented Method

The classification and display of the connections between information that is linked in complex ways is referred to, in the abstract, as a “graph,” with the individual information items being referred to as ‘nodes’ and the connections as ‘edges.’ The accrued knowledge on this subject has been brought together under the study of graph theory since the 1980s.

The German version of Wikipedia (http://de.wikipedia.org/wiki/Graphentheorie, cited 3.4.2012) says about graph theory:

“Graph theory is a branch of mathematics that investigates the properties of graphs and their interrelationships.
. . . Because, firstly, many algorithmic problems can be reduced to graphs and, secondly, the solutions to problems in graph theory are often based on algorithms, graph theory is also very important in computer science, in particular complexity theory. The study of graphs is also part of network theory.
. . . Numerous everyday problems can be modeled using graphs.
. . . In graph theory, a graph is an abstract structure that represents a set of objects along with the connections between these objects. The mathematical abstractions of the objects are called the nodes (or vertices) of the graph. The links between pairs of nodes are called edges. The edges can be directed or undirected. Oftentimes graphs are drawn graphically by representing the nodes as points and the edges as lines.”

In accordance with the actual state of the art in the technical implementation of the display of graphs, usually only the connections in a single “dimension” are shown in mappings, thus, in our example, those in the category “knows the person” or “belongs to school class”, with nodes then being connected to one another by only one edge.

However, it is possible (and useful for achieving our object) to consider multiple categories of links, and thus “to color the edges” of the graph, for example to represent relationships such as “person A likes person B” and “person B ignores person C”.

When displaying interpersonal relationships, moreover, it is realistically possible that “nodes” must be multiply connected, thus, for example “person A is a student of person B” and at the same time “person A likes person B”.

Graphs with multiple links between “nodes” are called “multigraphs.” Experts consider multigraph networks to be complex and difficult to map and to presentate because of their complexity. The limitations of the prior art solutions have already been described above.

In the said example, the system to be displayed, with its various categories, can be considered as a multigraph with multiple dimensions (multi-dimensional multigraph), for instance in order to presentate the categories “hometown”, “persons” and “favorite subject,” and their connections. Furthermore, these connections can be directed and circular.

Now, in order to presentate the information, each node must be displayed with all its edges and each edge with all nodes. Since this becomes unclear, and further because it is not possible to navigate in these network representations, the currently usual practice, even among experts, is to reduce the complexity of presentation to just a single dimension: then all the nodes are displayed, but only these relationships (“edges”) that define this single dimension. To do so, various types of graphs are drawn depending on the type of relationship; these graphs potentially can be infinitely large. A variety of methods exist for this purpose, which produce network presentations of varying design (see “Prior art, More complex geometric arrangements”).

In the case of the technical object we have set here, the requirement is appreciably even more complex, since it is to be attained for multi-dimensional graphs through the arrangement of the content items on a quite limited output area by means of an easily comprehended display. This is not possible with the conventional methods.

To map the content items, which have now been classified as multiply connected multi-dimensional graphs, the invention proposes a presentation with an only partial reduction in the content items mapped. The content items of the considerated “location in the data structure” under consideration are displayed, whereby the direction of view spots a certain category. The other categories that also are selectable at this time as a viewpoint are displayed in addition and arranged nearby.

In the example:

Multi-dimensional, multiply connected relational systems are considered from the individual node outward by the means of the present invention. (In the example, “student A” has the following relationships (edges) to other nodes: “member of class 1,” “favorite subject English,” “lives in Berlin.”) This collection of its relationships presentates the content of the remainder of the system in relation to this individual node, which is to say “from the viewpoint of the individual node” whereby it is possible to consider all categories.

The presentation of the connections to the content items of the applicable categories (e.g., “classmate from the same hometown”), and thus the arrangement of the content items, always requires a prior filtering in accordance with the desired arrangement. This is accomplished through separate computations of the links, whereby the links possible for the given viewpoint are ascertained and the associated categories are output.

The invention herewith proposes a new method, which is described in detail. It concerns the manner of arranging the content items and the links in the output accessible to the user. It also concerns the manner of executing the process of ordering the content items; this is, as noted, an implementation of a method that can also be carried out in a physical filing system.

In each step of the pathfinding, relationships between individual content items are presentated by displaying the corresponding representatives on the screen. The user then can use these representatives for purposeful selection of content items and for navigation. The arrangement of the representatives on the display area of the display device is recalculated after each selection process in order to adapt the arrangement to the selected context (=in accordance with the selection that has been made) while taking into account the technical conditions of the DP system.

In the case of an implementation with mechanical means, this corresponds to a rearrangement and reordering of the representatives; because of the complexity of the systems under consideration, however, this process cannot be implemented mechanically in practical life.

By means of the invention, this complex task is solved by a computer-implemented method and/or is implemented in a device that includes a computer and a computer program or a computer program product. The content presentated is kept available in prestructured data records. Processing with a computer system has the result that the output of the multitude of connections and the navigation (during the pathfinding) has to take place on the limited area of the output device (usually a computer monitor) in an appropriate manner. The output device, along with the computing power of the DP system, represents the system's technical limitations that the invention accommodates.

The arrangement of representatives described in the method also has further technical advantages:
fewer content items are displayed at the same time (as compared to a complete display of the multigraph in its entirety at all times);
when the currently active selection is changed, fewer computation processes are required for updating the displayed representatives;
the output, since it is arranged two-dimensionally and is less complex, can also be designed to be less resource-intensive. The invention consequently makes it possible to implement the display in a less graphics-intensive way, requiring a less powerful graphics card than is needed to output, e.g., continuously updated 3-dimensional graph displays (such as, e.g., http://truthy.indiana.edu/).

This also applies to output in three-dimensional space.

Designing the output as a primarily text-based display makes it possible to output the content of multigraphs on text-based output devices, for example by means of a refreshable Braille display or through speech output for the blind and visually impaired. This eneables many DP systems to presentate multigraphs for the first time.

### Completely New Starting Point:

Within the scope of the method, a dynamic observation of the content from the relevant point of view within the data is carried out during the pathfinding.

In so doing, the data and their relevance and visibility criteria are analyzed at each step, and the arrangement and visibility of the content representatives (displayed content and navigation elements) are implemented anew each time in accordance with the relationships of the data and the actually present course of the pathfinding, adapted to the technical conditions (capacity of the output device; outside influences as applicable). This complex process makes it possible to attain the object described.

The object is attained here by interpreting the content items in their relationships as a multigraph, which can also be very complex (for example “finite quiver”).

In this process, the content items are not displayed from outside and above, as previously attempted by prior art, but instead from “inside” the graph; in effect, the perspective of the view is from a content item (node) or an edge, or even, as became evident during the course of development, advantageously from an edge type (category).

This altered perspective provides the possibility of potentially infinitely long pathfinding activity within the network of relationships of data. By means of the invention, the user is provided with a way to maintain an overview and to spot the content items and selection options that are currently displayed. This is accomplished by means of the so-called “history.”

The technical object is attained by the invention in a novel way. It is realized in a technical implementation that takes the technical conditions of the DP system into account and, moreover, also makes it possible for less powerful DP systems to attain this object.

### Navigation:

In the manner described by the method according to the invention, the analysis of the structure of the data, that has been acquired and stored in pre-structured form, and of its connections produces an arrangement of the given information, together with a filtering of the information presentated, that permits access to every point in time during the pathfinding and to the then-relevant data content. It makes its connections visible and—because of the arrangement of the information items in their connections—immediately accessible. This method of information presentation directly allows navigation to all additional associated content items, which would scarcely be discoverable through a conventional menu structure.

In this way, the relations of the content items are presentated in a new way, which not only makes the obvious relationships accessible, but also those relationships that are potentially present in the system under consideration but have hitherto remained concealed, even for experts.

In exploring these connections, one goes on a journey through the data as he carries out the “pathfinding”. In concrete terms, this pathfinding takes place through the selection of content representatives in the form of text or graphic fields that are provided with a “link.” These “linked” elements can be, e.g., category names or element names. At all times, some of these elements are available for selection, so that the user can always move “forward” through the data, which is to say he can arrive at other ‘locations’ within the network via additional elements, which can provide new “views” onto the content.

In effect, the movement through the data traces a “path” through the data. Each step opens up a new “view” onto the data. This path is potentially infinite in length.

### Pathfinding

In the complex interlinked relationship network from the above example, the aim of the invention is to make connections visually accessible by making it possible to view the content items from an wide variety of “views.”

A certain “view” of the content is determined by listing the content items output in a certain order or by means of a definable filtering of the content, such as by a category (“content items” can now be “nodes” as well as “edges” of the graph under consideration).

The “view” onto the content can be changed in each case by selecting a different default for the presentation, for instance a different type of list or ordering of the output content items, or by a different filtering of the data, for instance by a category or connection type (type or content of the edge, which is then displayed via the category name or connection name).

This sequence of selection steps for obtaining different “views” is referred as “pathfinding”. The output of this pathfinding is an aspect of the invention that is introduced as a complement to the requirements of the task, and that is surprisingly advantageous. Displaying the path and the pathfinding increases the usability of the presentation.

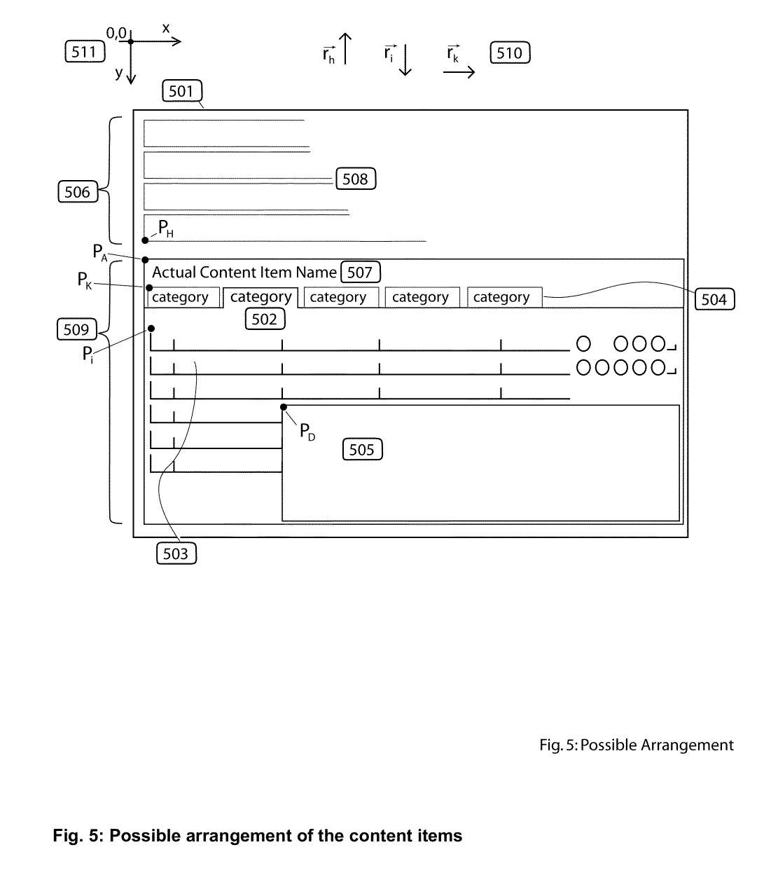

By means of the solution that has been discovered, the potentially infinite series of pathfinding steps can also be displayed on small monitors. An exemplary arrangement of the elements is proposed in FIG. 5.

When doing such an exploration it is possible to carry out an arbitrarily complex and potentially infinitely long series of selection steps (the “pathfinding”), through concrete points (in the given example e.g., “person”) and the categories (e.g., “membership in school class”, “parents' occupations”, “sports team”, “hometown”) connected to one another through these points. Steps of this pathfinding are stored in the “history”.

Through the history, the sequence of views, which then results in certain findings and conclusions by the user, can be retraced by the user. Thus, for instance, selection processes that did not lead to the goal can be reversed, and the path to the currently displayed “view” of the data can also be retraced.

Moreover, in addition to the potentially infinite forward movement that is always possible, this visualization also makes possible backward movement through the path.

### History

The invention implements a “history” to permit the display of the relationship and the prior selection of the current view of the potentially arbitrarily complex content of the multigraph during “pathfinding.”

According to the invention, each step along this path at which a change took place in the “reference” of the view is recorded, which is to say, for instance, when a different content element was selected. These steps can be output separately from the data itself in the form of a history list of the selection steps taken, with the earlier part of the list not being displayed visibly.

By this means, the user can retrace the “path” and reactivate each step that was associated with a change in the reference point, since the immediate pathfinding predecessors of the presentation output currently being viewed are always displayed in the history.

The view referred to by the history entry is output when selecting the corresponding entry; in other words, the output that was visible at this step of the pathfinding is reactivated.

The history list that is output is recalculated with each jump or step along the path, and its content item representatives are recalculated. It then represents the steps preceding the “point in time” displayed at that moment.

In this way, the history can always be retrieved in its entirety, and permits full navigation through all preceding selection processes.

### Summary Description

To move between the different states of presentation is to move between different ‘viewpoints’ or ‘views’ onto the data. This movement takes place when the user initiates it (or it is automatically triggered). The user initiates it, for example, by selecting and clicking on a term with the mouse. This selection can also take place by means of any other pointing device or input device or by automatic timer, and it is also possible to select, e.g., the whole row or a symbol.

By means of the method, the invention makes connections accessible in a completeness that reveals to the user additional connections, even such connections that would not be immediately obvious to him from his own knowledge. When he investigates these data connections, moreover, this shows him new connections extending beyond the interrelationships established by the data acquisition, if such connections exist.

The inventive arrangement of the content items causes a novel “menu” to be created that permits continuous “forward movement” through the data content. This arrangement can be employed to good advantage in many fields. The innovation presents a new kind of user interface towards graph data.

In addition to user-friendly “forward navigation” within the content structure, the invention allows the path that has already been navigated to be displayed in an easily understood manner and also allows the user to “go back” to previously active selection conditions, for example to a previous view, if desired.

The number of logical link levels that can be traversed in the “forward” direction is limited only by the logical links and the rules of visibility applied on account of access rights, if applicable. The path created during the course of this “pathfinding” in the content can potentially be infinitely long.

The number of selection steps that can be traversed “backward” can extend as far as the start of the session or the re-production of the initial view of the user interface. Presentation of the “history” makes this “backward movement” possible.

### Method According to the Invention:

The invention teaches a novel method in order to output content linked in complex ways in a limited display space or in a limited display area, while presentating the complex links of said content. This method describes the way information is presentated through the arrangement of elements representing the content. In addition, the method teaches the optional arrangement and design of the pathfinding history (“history”).

### Terminology

Explanation of the method and also clarification of the terminology (insofar as this is not done elsewhere):

### Technical Implementation:

The method can be implemented by technical means, e.g., using a DP system on which the method is implemented by means of a computer program. How the arrangement and display of the representatives on the display area is done is dynamically determined according to the method of this invention. The technical conditions of the DP system affect the sequence of the method.

The DP system on which the program implementing the method is used consists of one or more computers (203), has direct or indirect access to at least one user interface (e.g., 501) and at least one output device (204) and to at least one input device (202) such as, e.g., keyboard, mouse or touchscreen or network-interface, stores programs and data in at least one memory (308)—implemented, e.g., as a harddisk or flashmemory—, loads data for computation into at least one working memory (305), executes algorithms described in the software in at least a portion of an arithmetic logic unit (303), manipulates data there in accordance with its design, if applicable writes the results to the volatile or nonvolatile memory (305,308) and reads the results therefrom. It outputs (108) data by appropriate piloting (112) to a output device (204), e.g., a display device. These tasks can also be carried out with various task distributions by one or multiple computers (203) that are connected together in any way, or if applicable by computer systems of different kinds.

For using the method, the program on the DP system can be actively controlled by the user via at least one input device, which is directly or indirectly connected to this DP system or is a part thereof, or through program control such as, e.g., timeout. The outputs generated by the computer program can be output on an output device (204) connected to this or another DP system, e.g., displayed on a monitor.

The computer program can be implemented in any desired computer language, for example in procedural or object-oriented programming languages such as php, Java, C#, C++, perl, Python, Ruby, JavaScript, etc. The program may consist of one or more parts. The program may ascertain the characteristics of the output device of the DP system, or they may be communicated to it (for example, by means of parameter files). If applicable, the program may also react to additional, external conditions or inputs, for example to the time of day, weather data, physical quantities such as temperatures, etc., which are communicated to it through the input (202) or the interface (307), and react accordingly to these conditions.

The computations described take place within the program in accordance with definable and describable rules (algorithms),
by means of which the selection of the content items can be computed in accordance with at least the information links, as applicable in accordance with selection steps already taken (history), and as applicable with additional influencing variables or data accessible through the interface, and
by means of which the arrangement of the representatives and their visibility are determined in accordance with the influencing variables, which is to say, for example, predetermined boundary parameters, or geometric constraints, or the given conditions or the features or the capacity of the output device, and additional influencing variables as applicable.

When arranging the content, the invention considers the technical implementation of the DP system employed—in particular, the size of the output area is taken into account in determining the arrangement of the content for output in this area. This can be done through an ascertainment of the dimensions of the output area that is integrated into the program sequence, for example, or by comparison of the ascertained output device with a list of mapping dimensions, or by an entry in a device-specific list or parameter file (e.g., .ini file), or the predetermined limiting of the dimensions of the output area to predefined values (default values).

The configuration of the rules also has effects on the type of storage and the content of the memories (305,308) and the stored content in the memory (308) of the DP system being used.

### Content and Content Items:

The content of the considerated data-set is derived from complex situations of real life. The objects and relationships that exist or can be intellectually conceived there are stored in a data structure. The resultant content items consist at least of categories, individual content elements, and content details as applicable, as well as of links between arbitrary information elements or information details.

These content items are rendered to the output in the form of representatives (text, graphic symbols, graphic markings) of content elements, content details, and categories and navigation elements for selection.

In accordance with the invention, content items are at least categories, content elements, detail content, link types, and presentation contexts; when considered as a “graph,” all content items of the system under consideration can be understood as nodes (data) and edges (links). In addition to directed graphs, undirected graphs and mixed graphs, multigraphs as well as “quivers” can be presentated in this regard. A quiver or “multidigraph” is a directed graph which may have more than one arrow from a given source to a given target. A quiver may also have directed loops, in this case also via more than one nodes.

These content items can be present as data records in a database in the data memory, as individual files of the same type or even of different types in a single computer or distributed across multiple computers connected to one another; they can also be elements of different types or even physical objects (“records”). These content items can each contain additional data (internal data or attributes). Content items consist of one or more content elements (nodes) and the associated links (edges), which in turn can be associated with categories. (For further information, please also see below under “Data management.”)

Content elements correspond to the nodes of a graph, and depending on the type of content, a separate graph (which is to say a separate reference system) can result. The type of link (edge) can be reflected in the entry into a category or in a property of the content element. Content elements can have additional detail content items associated with them, although considered per se, these are also just content elements. Content elements are always considered to be connected to other content elements when they are classified in the same category with the other. Content elements can be classified in multiple categories. The described database normalizations permit a very appropriate segmentation/structure of the content.

Content elements are classified into categories. The categories are defined in accordance with the purpose/the content or subject area/the desired use for the database/the application. Therefore it is possible to notate the categories in any desired manner (within the content elements or by means of a notation structure separate therefrom, e.g., as a separate database table). The content elements are logically linked to other content elements through the membership in categories—as a result, a “content level” is sprout. The finite number of content elements is associated with a finite number of categories, wherein one content element can be associated with one or more categories. Categories can be understood as types of edges of the graph. Since links between different categories can exist next to one another, a complex structure of different interwoven graphs can come into being (multiply connected multigraph). Regarding links of a particular type (category) makes it possible to consider a dimension of the graph; from the viewpoint of the content items this is a “content level.”

“Currently present categories” are inherently always the categories in which the current content element is classified.

Categories are not linked with one another ‘per se’: a linking takes place categorically through the inserted content items. A link between categories can exist, e.g., for the purpose of facilitating input of content.

A weighting and a name can be assigned to each category.

As ‘current category,’ a category can influence the process flow of the method.

Depending on the presentation context of the content element, different categories can have different importance. To this end, a weighting of the categories can be undertaken, which determines the sequence of the arrangement and the details of the visibility during the process flow. Weighting means the application of a factor. The weighting can be dependent on the context of the presentation.

The output of categories can be determined by the weighting in accordance with the presentation context, so that if the categories occur they are arranged in a defined sequence or are not displayed, as applicable: for example categories with medium weighting can then optionally be included in the output of the categories, categories with low weighting are not output as applicable—depending, e.g., on the screen resolution.

Main categories are the categories that are necessary or relevant for considering the applicable situation of issue; they are defined prior to the start of arrangement, e.g. in the program configuration, or later through computation or determination as a subset of the categories. Additional categories can also be determined, e.g., automatically in a computer program module.

The presentation context is described from the view of the current pathfinding situation. The presentation context comprises, e.g., the current selection of categories and history of category selections, content items, current content element, currently present categories of the current content element, currently active category, as well as, if applicable, user rights (access restrictions) for selection and visibility, and conditions determined by the technical circumstances of use such as screen resolution, screen size, specifications of the output device, resolution of the input device, etc. There is a potentially infinitely large number of presentation contexts in any given situation.

“Pathfinding” is the capability and the process of moving through the data. This can take place by selecting a content representative, thus making this content item the “focus” of the presentation—or the element or criterion that determines the presentation. (In the description of the process sequence, this then becomes the “active element” or “active criterion”) (1712,1704).

In this way another view of the data and within the data is obtained. The result of a changed view of the data is the changed content of the output, which means that different data content items are output, or their representatives are arranged differently, or both.

“History” is the log and list of the selection steps that were taken during the pathfinding.

Information representatives (“representatives” for short) are elements that are visible to the user and are arranged in the output area (or the output space) in order to display the information corresponding to the information element and the presentation context in each case. They are the embodiment of the (abstract or concrete) information of the content elements. They can occur as, e.g., textboxes or picture boxes. Information representatives each have a (geometric) extent, which is to say height and width, for example. These can vary in accordance with the presented content (e.g., depend on the word length), or can be fixed (e.g., the width of the main categories or the (geometric) height of the individual levels). The specific design, e.g., height, width, coloration, etc. that is given to the information representatives depends on the particular screen design and is not part of the present invention.

The method describes

a) the manner of delimiting the content items from the total data set/content and
b) the manner of arranging the information representatives in the output generated for the output device. This takes place in accordance with the technical conditions in effect at the time of the arrangement and the relationships in the content. The type of arrangement and the visibility of the content items displayed is always defined in accordance with the given presentation context.
c) the method describes further the implementation and arrangement of the representatives of the output content of the stored history, which can be output in association additionally, in accordance with the presentation context.

The user can initiate another execution of the method by selecting the representatives displayed (see “Pathfinding”). The method is then executed, and can redetermine the content items that are output and the arrangement of the representatives at each step of the pathfinding.

The method consists of multiple steps:

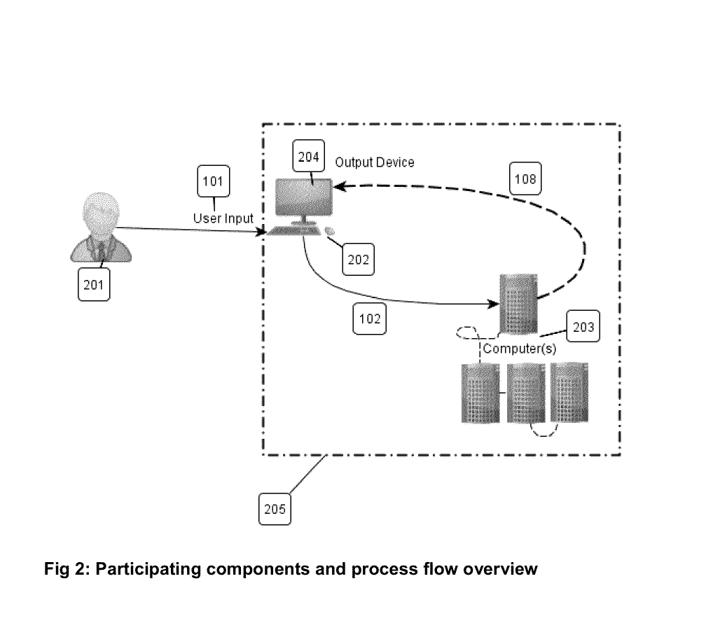

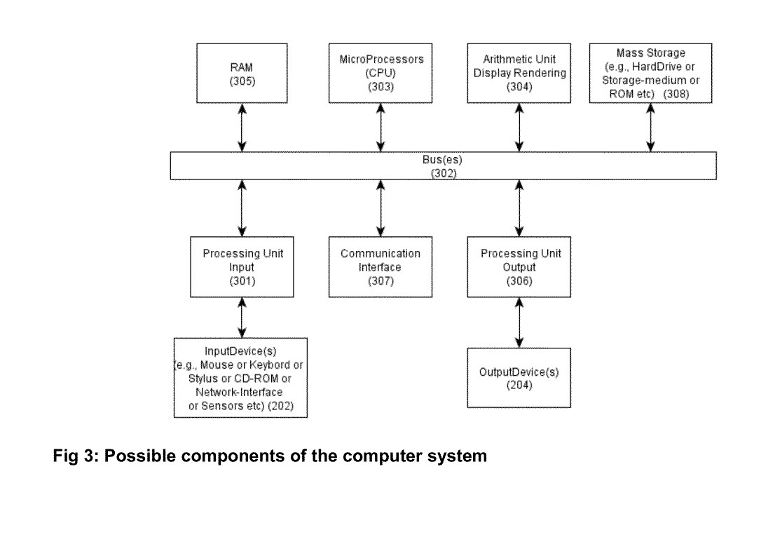

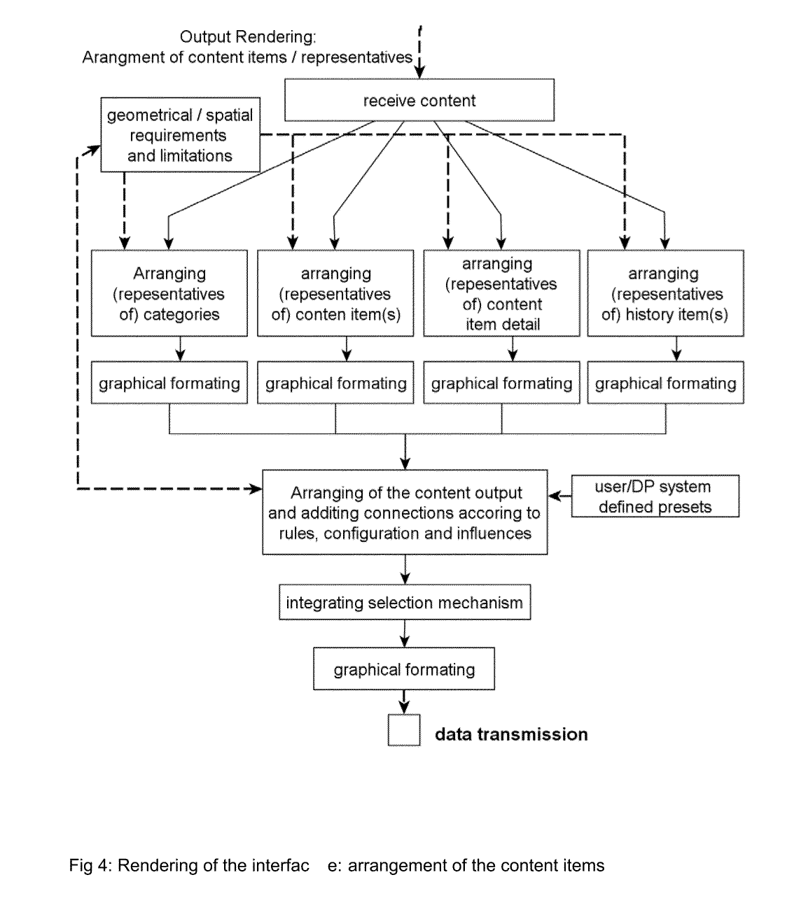

a) Determine status; if applicable, store data management information (for example, entry in the history) (102)
b) Assemble/determine content items:
retrieve (105) the content items from the data memory (305, 104), and if applicable (107) reduce the content items in accordance with the history (selection history) and other influencing variables as applicable (capacity of the output device, physical or external inputs)
c) Determine the arrangement of the content representatives (109 and FIG. 4)
in the various geometric directions (for example, two or three, which is to say, for example, horizontal, vertical and into space) (110)
as applicable, order the content representatives in accordance with the content
as applicable, filter the content, e.g., in accordance with a predetermined number or in accordance with the output capacity of the output device that determines the number;
as applicable, compute and determine the visibility of the representatives in accordance with a predetermined number or in accordance with the output capacity of the output device that determines the number;
   d) Control the output device (112), and output (108) to the output device (204) (e.g., display screen).

Technical means for this purpose include
filtering the content items in order to reduce their number at this stage; which is to say
   evaluating the content relationships (links)
   evaluating the selection processes that took place earlier
including (114) the external influencing variables in the computation of the output which is to say technical limits/conditions of the DP system
   display/output capacity of the output device
   size and quantity and arrangement of the representatives and technical conditions to be taken into account in the output as applicable
      such as, e.g., time, duration, temperature, etc.

### Description and Application of the Method

### Data Management:

In preparation for use with the method according to the invention, the known data about the matter to be represented are stored. The data are stored in any customary database, for example in text file-based databases, or in relational databases such as, for instance, MySQL, Oracle, Sybase, dBase, SAP, etc., or in object-oriented databases, or network databases, or graph notations as, for instance, EdgeListFormat or AdjacencyListFormat, or others.

The individual data content items and their relations can be arbitrarily complex, as has been demonstrated. Since the links can be complex, the stored data are converted into a non-hierarchical arrangement to the greatest degree possible. The database may conform to one of the following forms: Boyce-Codd normal form (BCNF), or fourth normal form (4NF), or fifth normal form (5NF), so the data structure is optimized for this use.

For the purpose of management, cross tabulation tables, which contain references to the content that is subdivided as far as possible, and the associations thereof, e.g., with categories, types of connection, other content items, etc., are used by preference.

### Steps of the Method in Detail:

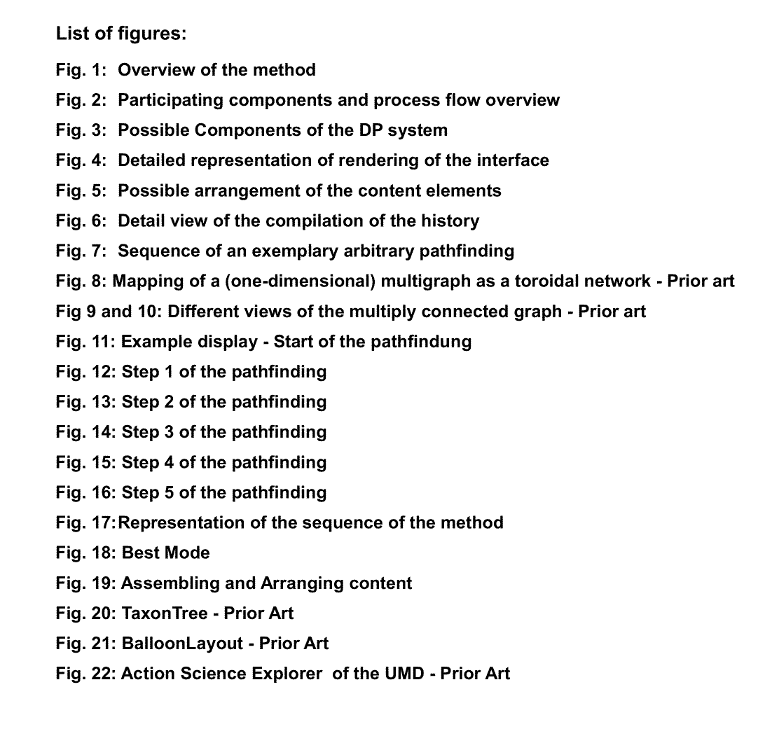

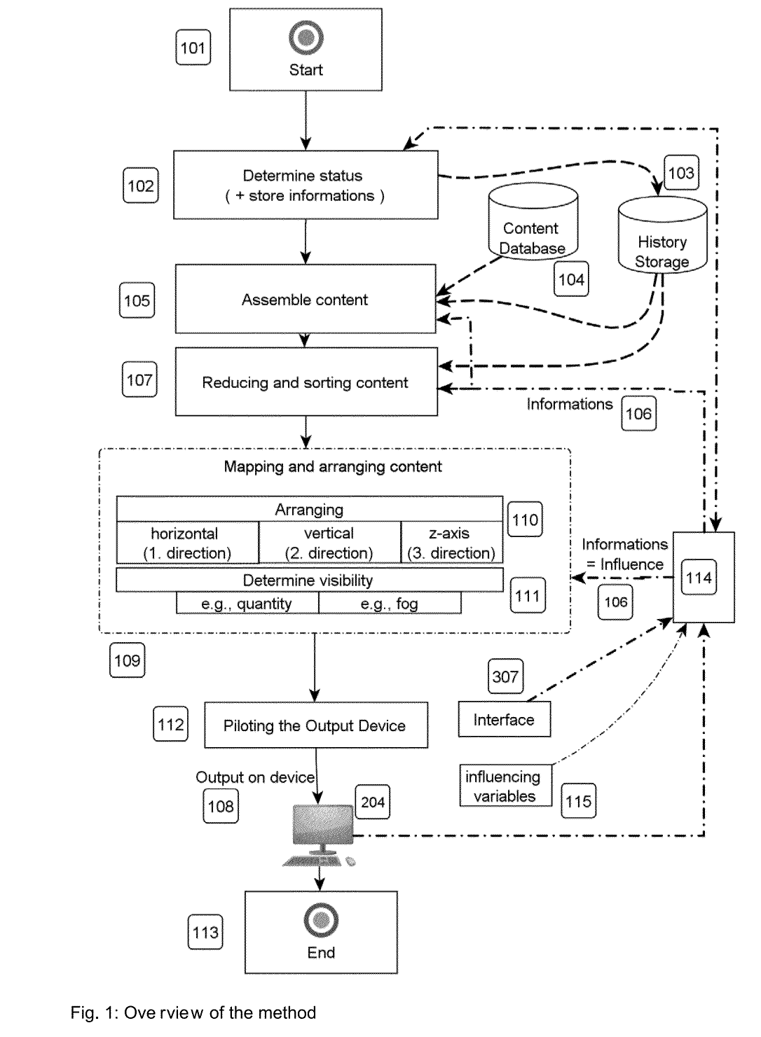

The method has multiple steps, some of them optional. FIG. 1 shows an overview of the steps.

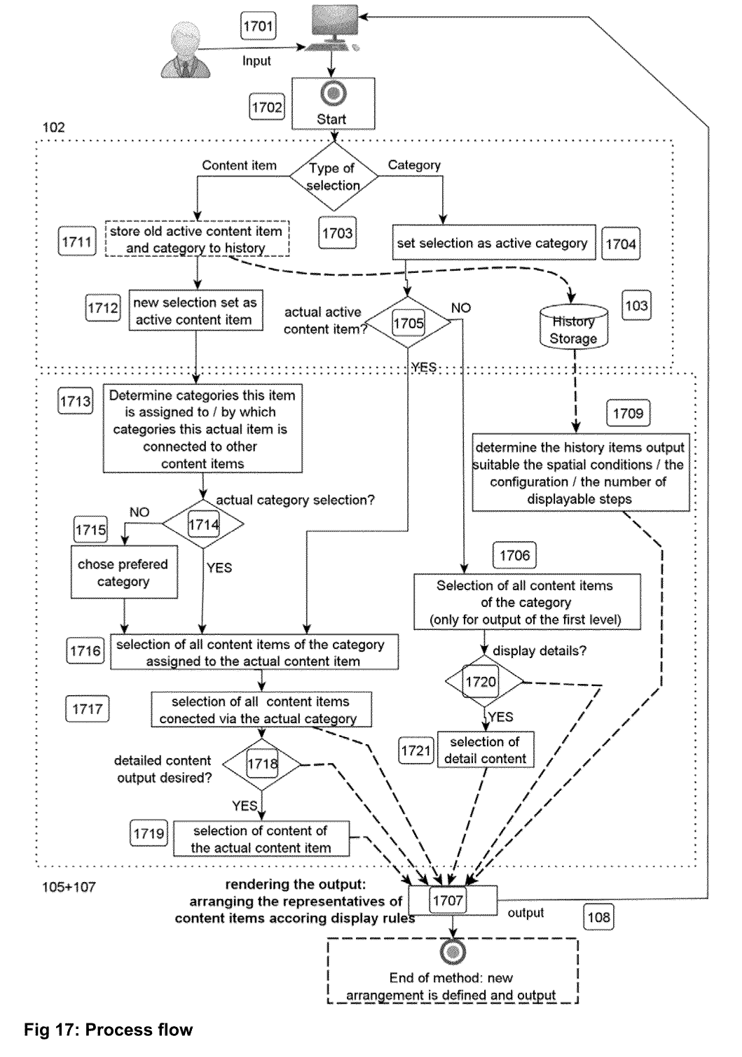

FIG. 17 describes the steps “determine status” and “determine content items”, but only briefly describes the steps “arrange content items” and “output.” Those steps are shown in detail in FIG. 4

The method is initiated and started (101), e.g., by a user interaction (1701) in which the user, e.g., selects an element in the display of the content. This can be done e.g., by keyboard input, by clicking with an input device such as a mouse or a stylus, or by another interaction, such as speech input or input from other peripheral devices, or by, e.g., a timer or a input through an other interface (202, 307).

The computations and selection processes required in the method take place on a computer system (203) e.g., through a program or a program module, e.g., by comparison of content lists that are stored in permanent memory (308) of the computer system, loaded into the working memory (305), compared by means of comparison algorithms in the main arithmetic logic units (303,304) of the computer system, and whose arrangement is computed there; the computation of the mapping of the arranged content items takes place in the part of the arithmetic logic unit (304) responsible for output, and the content items are then displayed via an output processing unit (306) on an output device (204), e.g., on a display screen.

### a) Determine Status

In the method, the selection steps, as well as additional data management information if applicable, e.g., information about the time, are stored for the history in the history storage (103). This storage can take place at the start of the method (101) or the first step (102), but also at any other time. The illustrations are to be understood to be merely schematic in this respect.

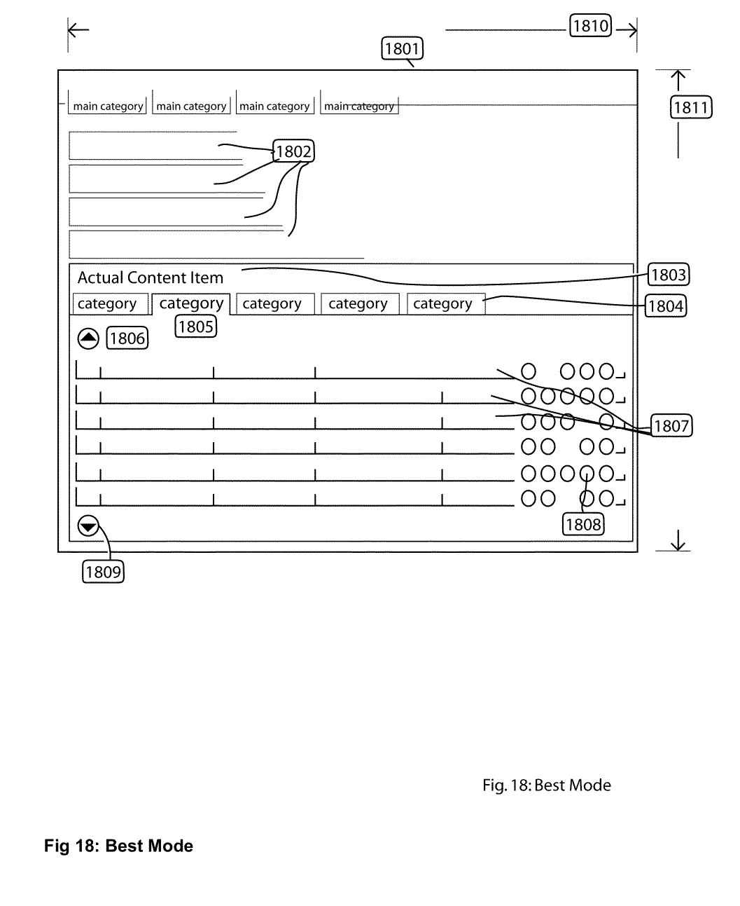

Ascertaining the geometric conditions (114) of the output area provided for the output is a fundamental necessity for the method. This can be done right off at method start, or at a later time. The capacity of the output device (204) is ascertained by means of e.g., a display dimension query, which is integrated in the program. In this process, the number of pixels (dots) in the horizontal and/or vertical directions is queried. This can be done by means of the programming language or by any other means. Also or alternative to that a parameter file (e.g., .ini file) specific to this DP system can be present, which can if applicable contain the screen resolution and also additional parameters, such as the number of rows to be displayed in the history, or information on the subregion of the display area to be used by the history, as well as a fixed row height. This information (106) is used amongst others to calculate how many entries can be listed in the history and the content list before it is necessary to switch to another display page. One possible implementation is shown in FIG. 18 “Best Mode.”

### b) Determine Content Items:

As described, the intellectual process of ordering consists of determining the applicable ordering criteria for the considerated content in each case. In daily life, the determination of ordering criteria as the basis for the order to be established is followed by the labor of ordering, which is to say the rearranging and (as the case may be physically) sorting of the things to be ordered, for example into “stacks.”

In analogy to the process of “making stacks” in daily life, the ordering and sorting in the method according to the invention take place in the following substeps. In these substeps, the selection of content elements are reduced and sorted into different stacks (107) and are then passed on to the next steps (109) of the method, where they are mapped onto appropriate representatives which arrangement (110) and visibility (111) is computed.

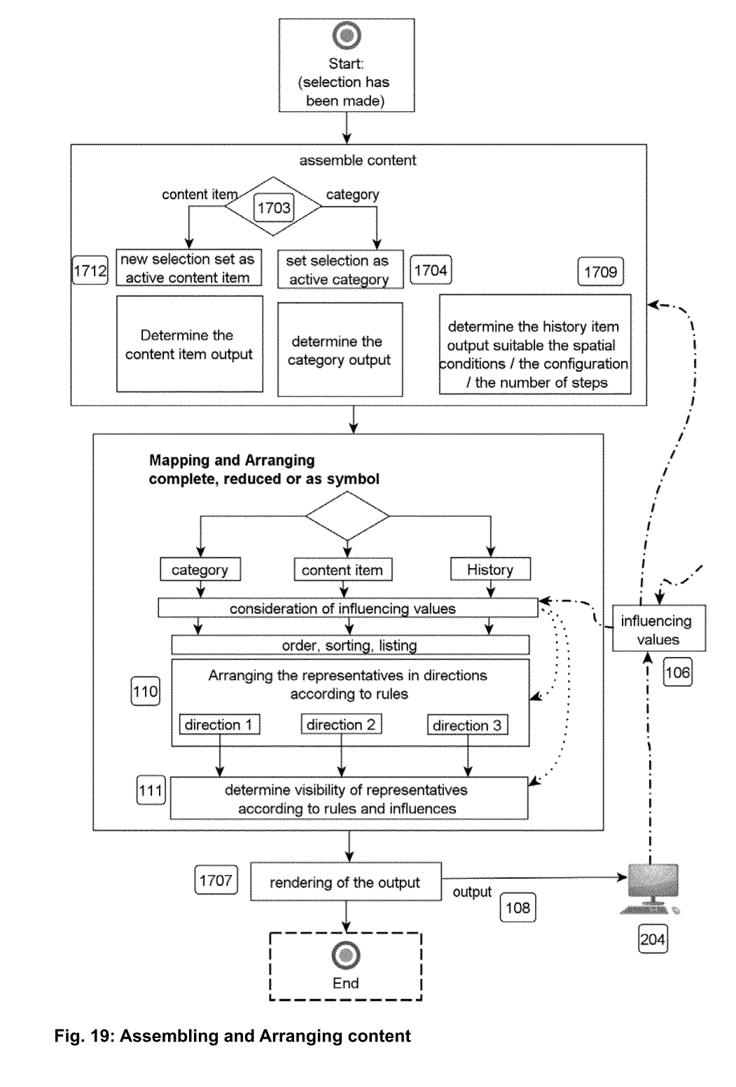

The sequence of the activity in step (107) differs as a function of the present starting situation (in detail see FIG. 4 and FIG. 17). The ‘mapping and arranging’ (see FIG. 19) and the rendering of the output (1707) of the content to be displayed takes place in each cycle and is described in detail further below.

### Typical Substeps of Sorting Content (107):

a) If no content element is currently set as active (in other words, has been selected as the presently active content element), then the ‘main categories’ (see p. 30) are selected (1706) for output and are output to display (108). This applies in the initial ordering before the start of the pathfinding, for example.
b) After the input by selection (1701) of a displayed element, a distinction by programming means takes place (1703) as to whether a category or a content element has been selected.
c) If a content element was selected, then on the one hand all categories that stand in connection with the content element itself are selected (1713) and output, because that element itself is classified in these categories; on the other hand, all content items filed in the currently active category with that content element are selected (1717) and displayed if applicable. If there is no currently active category (1714), a category is selected (1715) in accordance with the weighting and the display situation.

If, while arranging or sorting the categories for output, a category is found as be defined as the preferred category, it is, e.g., arranged first, e.g., in the initial output of a content element.

d) If a category was selected (also, e.g., as an automatic selection in the case of a preferred category), a check is made as to whether there is already a content element that is set as active (105).

If a content element is already set as active, all content elements that are likewise assigned to this category in addition to the currently active content element are selected (116) and output (107,108).

If no content element is set as active, all content elements of the selected category are output (106); for example, this corresponds to the first step of the pathfinding after the selection of a main category.

e) The content details that are optionally linked to the content element are optionally (118) listed separately (119) therefrom, and are arranged in the output (if requested and if associated content items are present). Similarly, categories and presentation contexts can have detail information items associated with them, which are optionally displayed in the output arranged separately therefrom.
f) If a new content element (in contrast to “a different category of the same content element”) has been chosen by selection, this can be stored as a new step of the “history” in a memory (103) by expanding the list of history entries (111) by at least the entry of the active or previously active content element, and also the previously active category as applicable. Other usage events can also be stored in the history.

The stored history steps are used for compiling the output of the history (1709, 506). When the “history” is displayed, the arrangement that is displayed is augmented in this case by a shortcut to the display context of the previously selected content element, which is provided with, e.g., a label (for example, name of the content element+category name) when it is output.

Computing the arrangement of the history is described in more detail further below.

g) When the user selects an entry (hereinafter referred to as a “shortcut”) of the history (506) to be displayed, the arrangement that was shown at the time of viewing represented by this “shortcut” is restored along with the selected categories and the content elements available for selection as they were arranged at that point in time. This likewise includes the display of the history (506): the shortcuts that were stored before the selected shortcut are then displayed therein again.

By means of this shortcut, the user can thus initiate a “return” to the previously selected presentation context, consequently reversing the “direction of movement” of the “pathfinding.” In this way it is possible to retrace the workflow and reestablish a previous state of the output of the selection step with its selection options. To this end, the presentation context and the selection that was stored with the shortcut are reentered in the process flow.

The number of logical link levels that can be traversed in the “forward” direction is limited only by the logical links and the rules of visibility applied on account of access rights, if applicable, thus it is potentially infinite.

The number of selection steps that can be traversed “backward” can extend as far as the start of the session or the production of the initial state, e.g., the initial view of the user interface.

### c) Arrange Content Items:

The arrangement of the representatives of the content elements is determined and technical implemented through the method. An exemplary embodiment of the arrangement can be seen in FIG. 5. A Best-Mode embodiment is shown in FIG. 18. This embodiments does not describe the graphic design, but rather the basic geometric (local-spatial) arrangement and the presentation of the different information content items through representatives and their links, which is to say an (exemplary) arrangement. For the shifting of the representatives the translation of the insertion point of the representatives is performed in each case by the directional vector r of the arrangement. This vector r is specific for each type of content (510), for example for the history item list it is rₕ starting at the point P_{H}. (see FIG. 5)

The representatives displayed and the arrangement of the representatives can be adapted during the output process (109):

the categories that can be selected based on the connections to the selected current content element (507) are preferably displayed in an arrangement in one direction as a list or series (504); the representatives of the content elements (503) linked by the category are arranged in a list (or series) in a different direction or type of arrangement. The sequence of the output of representatives of the categories can depend on the weighting of the categories, which is associated, e.g., with the current content element and the current presentation context.

Representatives of content elements can be displayed, e.g., as text, as symbols, as images, or as combinations thereof; the arrangement can be made, e.g., as a list, as a series in a linear or any desired geometric arrangement, as a regular or irregular or partially regular arrangement, in the same or different colors, color intensities, background textures or similar.

The geometric extent of the representatives can be fixed or variable. The size enters into the computation of the arrangement of the representatives of the content, which is also determined in accordance with predefined or calculated directives by the influencing variables of the technical environment, such as the resolution and display capacity of the output device, e.g., of the display screen (204), the available area (501), and/or other parameters (for example, entries in the .ini file, time, duration, temperature, etc.).

This takes place while considering, where applicable, established or limiting rights (access authorizations) for the output and/or the introduction of links that lead further.

This means the number R of elements in the set of displayed representatives is always less than or equal to the number of elements in the total set of information items i contained in the graph.

R≦Σ(i)

In conformity with the extent of the representatives of the ascertained content (content elements (507,503) in the content area (509), categories (502,504), history entries (508) in the area for the history list (506), detail content (505)), a determination is made as to which representatives are to be displayed and in what scope.

Thus a calculation is made that the total width of the representatives (R₁, . . . Rₙ) to be displayed is no greater than the total width Mₓ of the monitor (or another given number e.g., via the ini-parameter if applicable) (1810), and the height of the representatives less the height of the other elements (e.g., the history H) is no greater than the total height of the monitor M_{y} (or another given number e.g., via the ini-parameter if applicable) (1811)

Σ(R₁ₓ,R₂ₓ, . . . Rₙₓ)≦Mₓ

Σ(R_{1y},R_{2y}, . . . R_{ny})+H_{total y}≦M_{y}
where H_{total y}=Σ(H₁, H₂, . . . Hᵢ) or H_{total y}=n*H_{y}
   with n (the number of history elements) being defined by device-specific parameters, or by program default (standard value), or computation of the total height M_{y} from the factor h determined from device-specific parameters or by program default according to

n=h*M_{y}/H_{y}

If the limits should be exceeded, then the selection of the content items must be adapted to fit M_{y}.

The arrangement is performed according to the stated presentation rules, in particular:
the arrangement of the representatives of the content elements and categories (504) takes place in each case in perceptibly different geometric directions (different directional vectors r) or different manners of arrangement, where the output can be limited and adjusted in each case in terms of its quantity or content according to the influencing variables (e.g., screen resolution);
the arrangement of the history representatives (508) that are displayed as applicable is limited, as applicable, in accordance with the predefined or calculated number of output steps in the area for history list (506).

The invention can be linked to a management system in order to control the output of content. By this means, it is possible to, e.g., appropriately set the user's authorization, which determines whether content is to be output or hidden.

A check for authorization to output content items can be integrated, e.g., into the transfer of content in interface rendering (108) as well as in the arrangement (109) and the options for selection or at other points of processing, e.g. at (107).

Additional application possibilities:

Instead of an arrangement of the representatives of the content in a limited area, the method can also be used to achieve a three-dimensional arrangement of the representatives of the content in a geometrically limited space. In this case, the steps of the method remain as described, with the only differences being the geometric limitations on the arrangement of the content representatives, and the directional vectors. This permits output in, e.g., holographic projections. The input can then also be accomplished, for instance, by computing the positions of the displayed elements and sensing the user inputs (see, for example, VirtualTouchscreen by Siemens, U.S. Pat. No. 7,230,611 (B2)).

### Content Elements

Content elements are parts of the content and are arranged in a characteristic way in each case. The content element representatives are preferably arranged in a direction orthogonal to the category arrangement; for example, the representatives of the categories (504) are arranged horizontally and the list of the content elements (503) is arranged vertically, as shown in FIG. 5.

The other categories—standing in connection with the current content element (507) through its association therewith—are output in their thereby provided compilation (504). The arrangement of the representatives of this selection of categories is preferably aligned to the representative of the main category (502). Thus these representatives are arranged, e.g., in a common direction with the main category representative and use the same directional vector in the computation of the translation for computing the insertion points of the representatives.

The content element representatives are arranged in a homogeneous arrangement, preferably grouped in a defined direction (similar directional vector r), e.g., as a list in vertical direction (503,1807).

The starting point for the content item elements is the point Pᵢ.

The directional vector for the translation steps of the representatives here would be, for example:

$${r}_{i} = \begin{matrix}0 \\ 1 \\ 0\end{matrix}$$

The arrangement is computed starting at the starting point Pᵢ by the translation of the insertion point of the representative corresponding to

tᵢ=height of the representative I_{Y}*rᵢ.

This type of arrangement differs perceptibly from the arrangement type of other content items, for example by the different direction (different directional vector r) from that of the categories. The starting point of the categories is P_{K}.

The directional vector for the arrangement is, for example:

$${r}_{K} = \begin{matrix}1 \\ 0 \\ 0\end{matrix}$$

The arrangement is computed starting at the starting point P_{K} by translating the insertion point corresponding to tₖ=width of the category K_{X}*r_{K}.

If the number of computed representatives exceeds the geometrical available area, it can be splitted into more sections navigable through navigation elements (1806,1809).

The detail content (505) of a current content element (507) can additionally be arranged visibly in the output area (501) if the presentation context permits or requires this.

It is possible to allow the user to determine the directional vectors, the starting points, or even the type of arrangement so that he can adjust the display of the output to suit his own requirements or preferences. The specifications of the arrangement rules remain unaffected when this occurs.

### Horizontal Display of Selection Options:

In accordance with the number notified to the program, or influencing variables such as the screen resolution, there is a maximum number of elements that can be displayed due to geometrical reasons, e.g., in a horizontal arrangement. The computation was explained above.

For example, the arrangement can take the following form:
Category1 Category2 Category3 Category4

In order to take into account the limited amount of space available for a large number of representatives, it is possible to arrange the representatives of the categories and their content in an adapted manner (111); for example, in such a way that their embodiment is only partially visible; for example only the left half of the representative is visible, its right-hand part then being covered in turn by the placement of the left half of the next representative. Or in that the representatives of the boundary regions (here, the preceding/following categories) contain information about these content regions (in this case, categories), e.g., “Category 1 . . . 11” . . . “Category 15 . . . 27”.

When a set of selection options that can be interpreted and displayed numerically (e.g., a number series) cannot be displayed, a ‘reduced’ presentation can take place such that a part of the set is output and the parts overflowing to the ‘left’ and ‘right’ are represented by a output such as, for example, “<x” or “0 . . . x,” whereupon the series is further displayed as follows: “x+1” “x+2” . . . “y,” and is likewise augmented as applicable at the right edge by the display of the further value range “y+1 . . . y+z” or “>y+1” or similar.

For purposes of simplification, it is also possible to omit an identification of the represented content regions, for example by displaying only arrows:

Example display of a scrollable implementation of the category list for a horizontal arrangement of the categories with two placeholders for preceding/following categories:

|<| . . . ory09 Category10 Category11 Categ . . . |>|

### Arrangement of the History

For this series of (past) selection steps in the “pathfinding,” the present invention proposes the method of the so called “history,” which stores the potentially infinite series of steps, but does not visibly output all of the earlier part of them.

When a fixed or calculated number of history entries is reached, a subset of elements of the total history list is selected for output to display. The design and arrangement of the representatives in the output achieve the result that the display of the history is intuitively obvious to the user.

This part of the method makes it possible to represent arbitrarily long sequences of operational steps on a limited display area, e.g., that of a display screen.

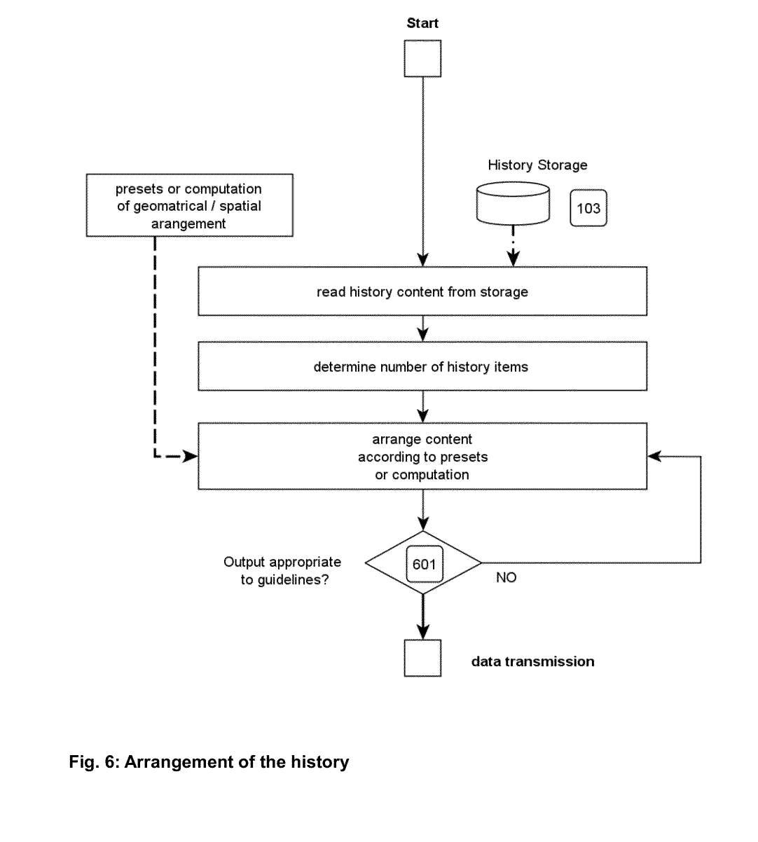

FIG. 6 shows the process flow for selecting the history elements.

All selection steps taken by the user are stored in a data memory (305,308), the logical levels currently present are counted in an arithmetic logic unit (304), and an algorithm is used to select for output only the appropriate levels in accordance with the predefined defaults. This takes place as needed, e.g., at every change in the content of the display, e.g., as a result of the user selection of one of the offered selection options. The arrangement and graphical processing take place during rendering of the output (step h).

The earlier steps of the pathfinding are thus only visible to a certain extent. This extent n (number of steps) depends on technical conditions of the DP system (for example, monitor resolution M) or on parameters that are set for the DP system (for example, entered in an .ini file) or defined by the output environment (for example, defined by the programmer for a web-based display in a web browser), and determines the number of steps to be output, or the number of pixels to be used for the history display, or the fraction of the overall resolution in the direction used for the history. In our exemplary arrangement the elements of the history are arranged vertically; the limiting factor here is thus the height of the available display area. The computation or determination of this extent is described.

The representatives are arranged with the appropriate directional vector starting from the point P_{H}. In our example, the directional vector is

$${r}_{H} = \begin{matrix}- 1 \\ 0 \\ 0\end{matrix}$$

In order to make this arrangement comprehensible and retraceable for the user, the visibility of the steps that are further from the point P_{H} is reduced: they are displayed less conspicuously, for example by the means that the color contrast between the foreground (text) and the background is made less intense, or the color intensity of the representative as a whole is reduced the more the representative lies further in the past. As a result, the representatives that are beyond the specific threshold are no longer displayed/output visibly; their visibility=0. As a result, these representatives can be arranged to be ‘stacked’ upon one another, if appropriate, so that they do not occupy any additional space in the limited output area. The points P_{A}, P_{D}, P_{H}, P_{K}, Pᵢ and the corresponding vectors are shown in FIG. 5.

This visibility of the representatives in the history list can be computed according to the formula:

Visibility reduction=current rank/total number of history rows

A visibility reduction of 0 means that the representative is fully visible; a visibility reduction of 1 or greater means that the representative is completely invisible; a visibility reduction between 0 and 1 indicates the corresponding percentage visibility of the representative, for example 33% at ⅓.

In this example, the display of the representatives in the output thus becomes lighter/less visible chronologically with the passage of time; this method is called ‘fog’ (111); other implementations for the purpose described are possible. It is also possible to replace the reduction in color intensity or contrast with another suitable measure, or even leave it out altogether. Moreover, the desired effect could also be accomplished by a change in the arrangement of the representatives, for example such that less of them can be seen the further in the past they are e.g., because, they are covered by elements located closer to the front, or are increasingly “rotated” so that their displayed area becomes ever smaller. The visible height of the representatives would then be computed according to H_{y}=1/m*h/n, with m as the numerator of the representative in its translation series. The directional vector is then computed, for example, from

$${r}_{H} = \begin{matrix}0 \\ ( 1 / m * h / n ) \\ 0\end{matrix}$$

### d) Output:

During rendering of the interface (display of the arrangement of the content representatives suitable for output) (1707), the above-described content representatives to be displayed, arranged in accordance with the defaults according to the method, are prepared for output to an output device and are then output (108), e.g., displayed on a display screen (204), making the content and further options for interaction perceptible to the user (201).

The arrangement is performed in accordance with the described arrangement rules and conditions; further rules and content may be included in addition.

The exact procedure of the arrangement is computer-specific and specific to the operating system used. For the purpose of arrangement, it can be assumed that the available display area (with the dimensions Mₓ (1810) and M_{y} (1811)) is divided according to a coordinate system that can correspond to the division into pixels, and the origin of the coordinates is located at one corner of the display area (511). The suitable placement for the arrangement of the previously determined representatives is calculated by computing the position. At least the geometric extent of the representatives and the displacement vector enter into the computation in each case, and if applicable also a deformation vector and if applicable other influencing variables. The defined points of origin (P_{H}, Pᵢ, P_{K}, P_{A}) are the starting point in each case for the different types of representatives. The implementation of the representative is designed in accordance with defined guidelines for graphic design, which are not part of the present patent.

In a complete pass through the method the elements are each determined first (107), and they are then arranged (109) in accordance (114) with the conditions that apply to the output device (204) and other variables (307,115), in order to then be output (108) to an output device in the “interface rendering” step (109,112,1707). The abbreviated description for this rendering and output step is “display” in this patent document.

### Advantages Attained by the Invention:

The invention describes the situation-dependent filtering, the computation of the arrangement, and the output of the appropriately arranged representatives of the content of complex networks of relationships. The art is enhanced in this aspect; the technical steps in computing the arrangement are identified, additional details are clearly evident to persons skilled in the art from the matter described.

For the user the useful effect is improved accessibility, making it possible to uncover even new, surprising content relationships as well as allowing easy navigation in the multiply connected content, consequently making the user's work much easier through more direct discovery, intuitive linking, and direct display of the links.

Furthermore, the invention attains the following conspicuous advantages:

Display of Multidimensional Networks of Relationships (Multigraphs)

The problem of 2-dimensional presentation of multi-dimensional multigraphs is solved by the invention. Using the arrangement presented herein, multidimensional networks of relationships can be displayed in an easily understood manner in limited display areas without “zooming”, resulting in good readability of content combined with a continuous overview of the selection options currently available at any given time.

Display in a Limited Area Through Automatic Arrangement

The automatic computation of the arrangement of the representatives necessary for displaying the content according their type (category, content element, detail, etc.) and according to the rules for arranging the representatives of this type according to their relationship to the current main element makes it possible to display the relationships fully and in an easily understood manner in a geometrically limited area.

As a result, this output is available on a variety of DP systems (computers, handhelds, tablets, etc.), specifically when technical limitations exist with regard to available screen resolution and graphics performance.

DP systems, in particular with text-based output devices, can experience significantly expanded utilization through the invention: the content of a multigraph can now be read using, e.g., a refreshable Braille display, thus opening up the utilization of this content on suitably equipped DP systems to a new audience.

Using the method presented by this invention, it is also possible to arrange information elements in spatial arrangement in a geometrically limited space.

This permits the easily understood display of information with multidimensional connections and the efficient use of this information in a novel way.

Advantages in Pathfinding in Multidimensional Networks:

Achieving the display of the “pathfinding” in multiply connected graphs, which, moreover, are intended to map different “dimensions” in the form of category memberships and, above all, make them accessible, is a technical problem that has heretofore been unsolved. This has now been achieved with the method described.

### Example

of the arrangement of information in one possible embodiment of the method according to the invention:

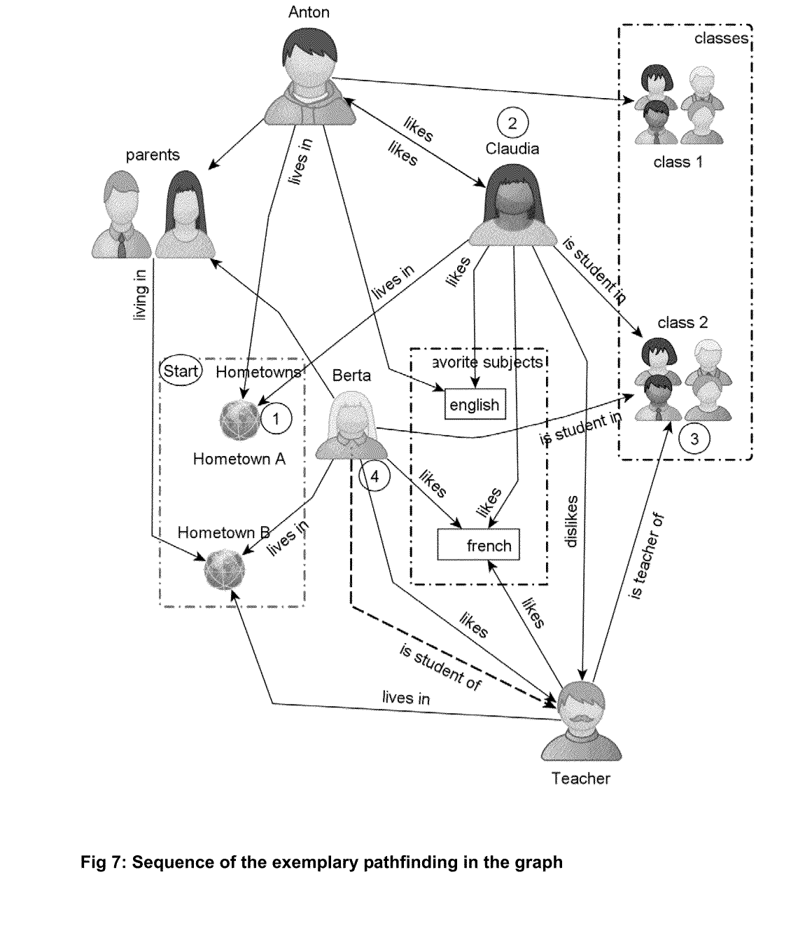

In the following example, the content items shown in FIG. 7 are arranged in the manner of the inventive method for display in a limited area. For a sample layout see FIG. 5. In this example, many possibilities covered by the method—but not all of them—are described explicitly; additional possibilities will be evident to those skilled in the art. A more advanced embodiment with the display of additional features that proved advantageous during development of the invention is shown in FIG. 18 (“Best Mode”).

To carry out pathfinding in the data, the presentation of the content items is laid out such that the user can see them on his output device, a display screen (204), and can select them using a pointing device (for example, a computer mouse). The selection process is accomplished by, for example, clicking with a mouse button. As a result, the method according to the invention is started and runs in accordance with the sequences described.

The “main categories” defined in this example implementation of the method are “class,” “hometown,” and “person.” These categories have the highest weighting and are arranged prioritized in the first row appearing (1101).

Additional categories that have different, but lower, weightings are “teacher” and “favorite subject”, for example.

The width of the display screen provides a limitation that has the effect of making it necessary to check at each iteration which of the categories can be displayed on the limited area by the corresponding representative. In the example, the limitation on the display space available is n=4 categories, since their representatives are always displayed with the same width.

Please refer to the computation modes.

In this exemplary implementation, the categories (504) are arranged horizontally next to one another; the content elements (503) are arranged vertically below one another.

The “history” is arranged here as a list (506) above the current category. Let us assume that the space available for the arrangement of the history is, for this example, limited to three rows contingent on the dimensions of the display device. In this example this number is defined for the assumed DP system in a device-specific .ini file (parameter file).

The history is displayed in a different graphic manner than the representatives of the categories and the content elements, in order to accentuate a distinction.

The different “stages” of the history are symbolically represented in the display below by a progressive adjustment of the color/gray values of the foreground and background. This results in control of the visibility of the elements, which then are not visible from the fourth element onward (see above for computation). The most recent history element is thus arranged directly above the current category, and the oldest at the top end of the list.

This ordering principle, and this arrangement, is defined for the assumed computer program in this example in a device-specific .ini file for the assumed DP system, since in this example the ordering is supposed to take place in this sequence and the arrangement as described—if the assumed DP system were equipped with a touchscreen, a system-specific parameter would be able to be changed for this DP system, and the sequence of the arrangement would be in the reverse direction (in order to facilitate ease of operation via the touchscreen).

The additional output of the effects of restrictions on the visibility and selectability of different content elements due to user rights has been omitted from the example. However, this is readily conceivable (for example, a student would not be allowed to view his teacher's address).

In like manner, additional external influencing variables could conceivably have an effect, for instance filtering of the displayed content by entry age with respect to the current date or the time that has elapsed since visualization.

The arrangement of the representatives is exemplified, and can also be accomplished from differently placed starting points in different directions; likewise, it is also possible to use, e.g., a touchscreen as the pointing device or, e.g., also to use control via speech input.

### Start:

Display of the main categories (1^{st} level):

The three main categories are arranged horizontally starting from P_{K}.

The limitation of the number of categories that can be displayed horizontally has already been addressed; it is checked at this point in the sequence. The result of this check is that 3 main categories are displayed, since no additional selection is active. 3<4, thus there is space on the display screen for the representatives of all (main) categories, and they are all output and displayed (1101).

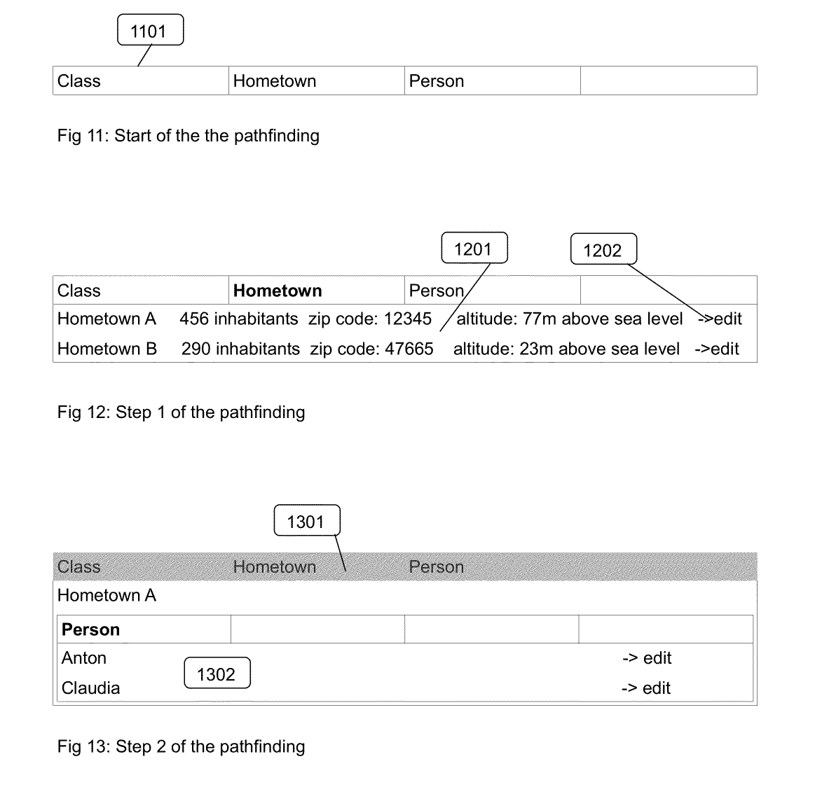

See FIG. 11: Start of the pathfindung

### Step 1 of the Pathfinding:

### Selection of the Category Hometown (Analogous to FIG. 7, “Start”)

Display of the content items contained in the category hometown by representatives in a vertical arrangement starting from point Pᵢ.

Here, it is possible to display content of the content elements, in this case, the number of inhabitants, zip code, etc. (1201); these can be arranged together with the main names of the content elements. Additional controls may also be arranged here, e.g., action fields for editing the content of the content element (1202).

See FIG. 12: Step 1 of the pathfinding
Step 2 of the pathfinding:
Selection of the Content Element Hometown A from the Category Hometown. (Analogous to FIG. 7, (1))

As a result, the categories with which the hometown is connected through its associated content elements are displayed. These can, but need not be, multiple categories. In the case of our example, this is only the category “person.”

The content elements of the category “person” are arranged vertically below the category name (1301).

The row with the categories from the first level is shown “shifted” into the history, symbolized by the gray background in the illustration (1302). The history now consists of one element that symbolizes a view of the data that we have already left behind us while pathfinding in the content. If the user wishes to return again to this view obtained earlier, he could select the corresponding row in the history, e.g. by mouse click.

The history is arranged above the representative of the current content element.

See FIG. 13: Step 2 of the pathfinding

### Step 3 of the Pathfinding:

### Selection of the Content Element Claudia (Analogous to FIG. 7, (2)).

The selection of the content element Claudia has now caused a number of steps to take place:
The history output was expanded by one row, which shows the selection made in step 2. The first row ‘slips’ further back in the ‘history,’ shown in the example by vertical displacement by r_{H} (upward), along with the graying of the text and the lighter background. Accordingly, the history now consists of 2 elements that are arranged vertically.
The selected content element “Claudia” is output. Its representative is arranged at the location where the current content elements were likewise arranged until now (1401).
all categories are displayed that Claudia is connected to. In this process, the default category is preselected and is arranged in the first spot, the other main categories are arranged horizontally adjacent to it, followed by the categories with lower weighting, in this case the category “favorite subject.” All categories are arranged in the horizontal direction according to r_{K}.
all content elements of the (default) category “class” are displayed in accordance with the “filter” Claudia; which is to say all classes in which Claudia is a student.

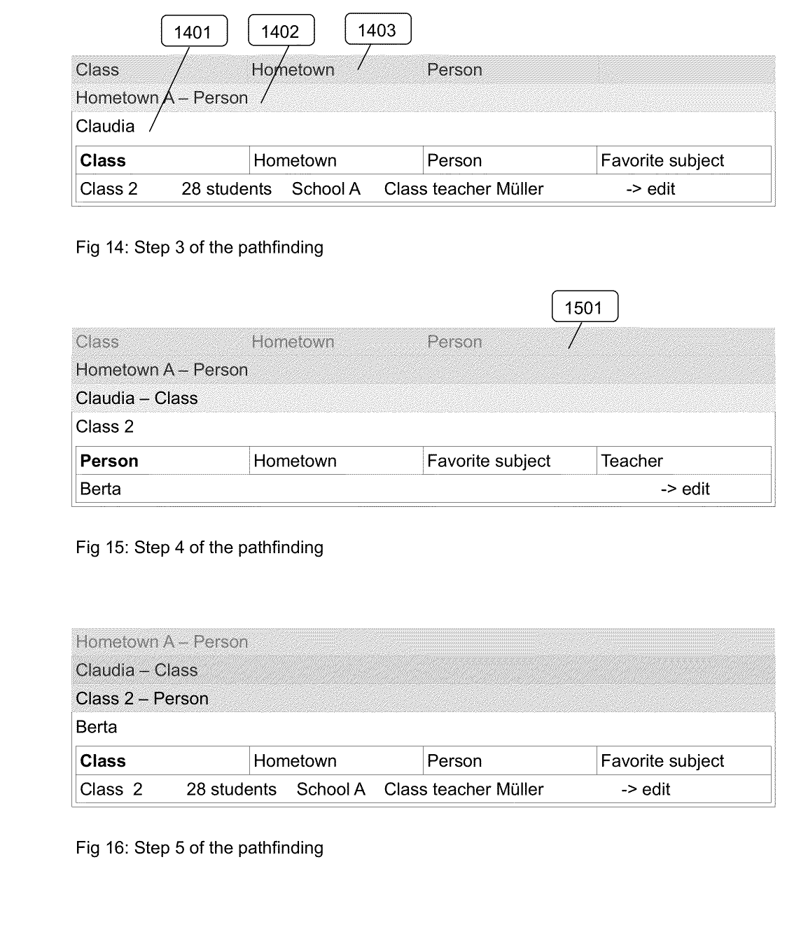

These are again arranged vertically in the content element list; in this case, there is only one element.
As already described, additional information items associated with the content element can be output, in this case arranged to the right of the content element, in exactly the same manner as the selection element for editing the content element and the associated detail information.
   See FIG. 14: Step 3 of the pathfinding

### Step 4 of the Pathfinding:

### Selection of the Content Element Class 2 (Analogous to FIG. 7, (3)).

The level “Claudia—Class” has ‘slipped’ into the history as a result of the selection of the content element “Class 2.” The history now consists of three elements whose progression is shown in the example through increasing lightness and the fact that progressively older elements appear closer to the top.
All categories are shown that “Class 2” is connected to through its content elements.
The content elements of the category ‘person’ are shown. Since, aside from the person ‘Claudia,’ who is part of the selection filter and therefore is not included further in the list of the content elements of the class in this example implementation, this category contains only the person Berta, so we see only one entry in the vertically arranged list.

as described above, further detail contents of the content element are arranged next to the content element, as is the corresponding selection option for editing.

See FIG. 15: Step 4 of the pathfinding

### Step 5 of the Pathfinding:

### Selection of the Content Element Berta. (Analogous to FIG. 7, (4))

The row “Class 2—Person” has ‘slipped’ into the history. Since the maximum number of 3 elements would be exceeded with this new element, the very first entry in the history is no longer output. Only the three most recent history steps are output in a vertical arrangement corresponding to the directional vector r_{H}. Consequently, three rows of history are now visible again. Clicking on the row “Claudia—Class,” for example, would also cause the very first row (which now is not output) to be displayed again—corresponding to the arrangement of the content items in step 3. It is thus possible to jump back and forth, or return to previous selection states as the previous presentation context (active category, active content item, previous selected items) will be restored as it has been by using the stored values as input in a newly computing of the appropriate arrangement of the representatives.
As already described above under step 3, the categories connected to the content element and the content items of the (default) category are output; this time for the active content element “Berta”.
   See FIG. 16: Step 5 of the pathfinding

Further selection steps and process flows follow a similar course.

1) Computer-implemented method, executed by means of a DP system comprising at least one computer unit, for arranging representatives of content that can be represented by a graph comprising information elements (at least nodes and edges), the content elements (nodes) of which graph are connected by edges of at least one category, whereby the representatives may be suitable to receive input commands, wherein the improvement comprises
the output of representatives of the category/categories and content element/elements is arranged with different directional vectors in different geometric or logical directions or dimensions,
influencing variables located inside or outside the DP system or the program exert an effect on the computations of the spatial arrangement of the output representatives of the information elements on the output device, by the means that the number and the geometric arrangement of the representatives and the visibility of the representatives are adapted to the given output interface, wherein
the geometry of the output interface, its size, extent, display capacity, or other externally determined influencing variables (time, duration, physical phenomena, control data, predefined parameters, device-specific settings) are taken into account in this process whereby
the method comprises at least one selection process,
a content element or a category can be set as active as a result of the selection,
after the selection of a category, at least a portion of the content elements of this category is output if no content element is active,
after the selection of a category, at least a portion of the content elements of this category that are connected to the currently active content element is output,
after the selection of a content element, at least a portion of the categories in which this active content element is classified is output,
after the selection of a content element, at least a portion of all other content elements that are connected to this active content element in the currently active category is output,
an output takes place of at least the representatives of the categories and content elements determined and arranged in accordance with said method steps,
the output takes place fully, in abbreviated form, or in symbolic form.

2) Method according to claim 1, further comprising the output of
detailed content items that are contained by the current content element or the current category, or that are linked thereto.

3) Method according to claim 1, further comprising
the storage of the “history”, the sequence of pathfinding selection steps with or without corresponding parameters of the presentation context.

4) Method according to claim 3, further comprising
the output of at least a limited number of steps from the progression of the “history” with or without a mechanism for reactivating a presentation context according to one of these steps.

5) Method according to claim 4, further comprising
determining the number and/or design of the output of the displayed steps of the history and/or the arrangement of the representatives of the displayed steps of the history on the basis of properties of the output device or the geometry of the output interface, or as defined by parameters or other externally determined influencing variables (time, duration, physical phenomena).

6) Method according to claim 1, further comprising
determining the number and/or design of the output of the representatives of the content items and/or the arrangement of the representatives of the content on the basis of properties of the output device or the geometry of the output interface, or as defined by parameters or other externally determined influencing variables (time, duration, physical phenomena).

7) Method according to claim 1, further comprising
the output content items can be edited and/or changed.

8) Method according to claim 1, further comprising
the step that the (spatial) location and/or the direction of the output of the categories and/or of the content and/or of the detail outputs or of a combination of said content can be influenced by the user.

9) Method according to claim 2, further comprising
the step that the (spatial) location and/or the direction of the output of the categories and/or of the content and/or of the detail outputs or of a combination of said content can be influenced by the user.

10) Method according to claim 4, further comprising
the step that the (spatial) location and/or the direction of the output of said content can be influenced by the user.

11) Method according to claim 6, further comprising
the step that the (spatial) location and/or the direction of the output of the categories and/or of the content and/or of the detail outputs or of a combination of said content can be influenced by the user.

12) Method according to claim 1, further comprising that the behavior, the visibility, the selectability, the arrangement in the output of the content or the access to content is limited or expanded by suitable rules (access rights) or by other parameters associated with the content.

13) Device comprising at least one computer and at least one computer program, with which the steps according to claim 1 are performed.

14) Device according to claim 13 that additionally comprises at least one input device for the user and/or at least one output device for output of the content in the arrangement according to the method.

15) Method according to claim 1, wherein the content representatives are output arranged in a geometrically limited area.

16) Device according to claim 13, wherein the content representatives are output arranged in a geometrically limited area.

17) Method according to claim 4, wherein the content representatives are output arranged in a geometrically limited area.

18) Method according to claim 1, wherein the content representatives are output (physically or projected or holographic) arranged in a geometrically limited space.

19) Device according to claim 13, wherein the content representatives are output (physically or projected or holographic) arranged in a geometrically limited space.

20) Computer program product that is stored in a storage medium and comprises software code segments with which steps according to claim 1 are performed when the product runs on a computer.

21) A user interface generating apparatus comprising an application program execution unit displaying an interface for observing content of a graph using a method according to claim 1.

22) A user interface generating apparatus comprising an application program execution unit displaying an interface for observing content of a graph (nodes and edges, whereby categories are defined by edges and the content elements (nodes) of which graph are connected by edges of at least one category) using a method to arrange the representatives of content of the graph onto a limited output area or space determine the arrangement whereby the geometry of the interface or the output device, its size, extent, display capacity, or other externally determined influencing variables (time, duration, physical phenomena, control data, predefined parameters, device-specific settings) are taken into account in this process whereby
the method comprises at least one selection process,
a content element or a category can be set as active as a result of the selection,
after the selection of a category, at least a portion of the content elements of this category is output if no content element is active,
after the selection of a category, at least a portion of the content elements of this category that are connected to the currently active content element is output,
after the selection of a content element, at least a portion of the categories in which this active content element is classified is output,
after the selection of a content element, at least a portion of all other content elements that are connected to this active content element in the currently active category is output,
an output takes place of at least the representatives of the categories and content elements determined and arranged in accordance with said method steps,
the output takes place fully, in abbreviated form, or in symbolic form.

23) Apparatus according to claim 22 whereby the representatives of content items are arranged in spatial different directions according to their type, comprising or not comprising output of a number of “history” steps.

24) Apparatus according to claim 22 with a mechanism to use the output representatives for user input to influence the said application program execution.

25) Apparatus according to claim 23 with a mechanism to use the output representatives for user input to influence the said application program execution.
